(19) United States
(12) Patent Application Publication
(10) Pub. No.: US 2004/0243259 A1
(43) Pub. Date: Dec. 2, 2004

(54) Method and apparatus for monitoring commodities in a batching system

(76) Inventors: Norman R. Peterson, Pewaukee, WI (US); Craig S. Mosey, West Bend, WI (US); Jeffrey J. Otten, Brookfield, WI (US); Chad Slipka, St. Paul, MN (US); Ken Hoover, Rogers, MN (US); John Jones, Minnetonka, MN (US); Steve Osgood, Sheldon, VT (US)

Correspondence Address: QUARLES & BRADY LLP, 411 E. WISCONSIN AVENUE, SUITE 2040, MILWAUKEE, WI, 53202-4497, US

(21) Appl. No.: 10/628,930

(22) Filed: Jul. 29, 2003

Related U.S. Application Data
(60) Provisional application No. 60/399,675, filed on Jul. 29, 2002.

(51) Int. Cl. G05B 15/00

(52) U.S. Cl. 700/84

(57) ABSTRACT

A batching system is provided for ingredients that are manually added to one or more batches of a production run. The ingredients are either reconciled or unreconciled, as mandated by the Food and Drug Administration. A monitoring station is provided for verifying that all regulated ingredients to be used in the batching system are accounted for.

### CROSS-REFERENCE TO RELATED APPLICATIONS

This application claims priority to U.S. Provisional Patent Application No. 60/399,675, filed Jul. 29, 2002 and entitled “Manual Commodity Execution System” the disclosure of which is incorporated by reference as is set forth in its entirety herein.

### STATEMENT REGARDING FEDERALLY SPONSORED RESEARCH OR DEVELOPMENT

Not Applicable.

### BACKGROUND OF THE INVENTION

The present invention relates generally to ingredient management, and in particular relates to a method and apparatus for managing and tracking FDA-regulated ingredients that are mixed in a batching system.

Cattle and other animal feed typically include a mixture of 1) a formulation (or batch) of bulk ingredients such as wheat, corn, and the like, and 2) a batch of hand added ingredients including drugs and drug mixtures. It is desirable to premix the bulk ingredients with the hand-added ingredients to enable the easy administration of drugs. The hand-added ingredients to be used in a batch are generally supplied in bags. The ingredients are removed from their bags in the desired quantities, and mixed with each other in buckets to prepare a hand-added batch. Typically a production run will include the preparation of several batches. Batches of the bulk ingredients are prepared using any conventional automated system. The batches of hand-added ingredients can then be added to the batches of bulk ingredients, if desired.

A portion of the hand-added ingredients are regulated by the Food and Drug Administration (the “FDA”). Regulated ingredients can include both controlled ingredients as well as certain uncontrolled ingredients. A controlled ingredient is an ingredient that the FDA requires to be 1) monitored by lot number and 2) reconciled. A lot number comprises any combination of letters and numbers by which any food can be traced during manufacture and identified during distribution. A controlled ingredient is reconciled by accounting for all quantities of the controlled ingredient that are removed from the corresponding bag. Accordingly, a reconciled ingredient is tracked to ensure that none of the ingredient is lost or removed from the facility. The designation of a reconciled ingredient is generally reserved for drugs such as Lasalocid along with other controlled substances suitable for animal use.

An uncontrolled ingredient is an ingredient that the FDA does not require to be monitored by lot number. However, the FDA may require that some uncontrolled ingredients be reconciled. For instance, premixes containing a controlled ingredient are generally uncontrolled but reconciled. One such example of a premix contains a carrier of corn and a percentage of a chemical added such as selenium in a quantity such that, for instance, the premix is labeled “selenium 0.6%.” Other hand-added uncontrolled ingredients are not reconciled, and typically include carriers that are not premixed with a controlled ingredient.

Conventional mixing systems comply with FDA regulations by manually tracking the bags and corresponding weights of reconciled ingredients. It should be appreciated in this regard that a bucket may be filled to a desired level of a given ingredient without completely depleting the bag containing that ingredient. As a result, the partial weights of bags must be manually obtained and recorded both during a production run and after a production run is completed. Accordingly, when the bag is used in a future production run, the previously recorded weight can be compared to the current weight in order to verify that no reconciled ingredients have been removed from the bag since the previously production run. Unfortunately, manual reconciliation is time consuming, paper intensive, and can be imperfect.

What is now desirable is a method and apparatus for automatically monitoring reconciled ingredients of a mixture.

### BRIEF SUMMARY OF THE INVENTION

A batching system is provided for controlling ingredients that are manually added to a batch via at least one transfer container. The ingredients include reconciled ingredients and unreconciled ingredients that are initially disposed in origin containers. The batching system includes a first sensor for measuring an amount of an ingredient in a container. A second sensor identifies an ingredient in a container. A computer communicates with the first and second sensors and having a user interface. The computer executes a stored program configured to identify a quantity and identity of a reconciled ingredient to be added to the batch from a recipe. The stored program also verifies the origin container of the ingredient to be added to the batch. The stored program further measures a quantity related to the origin container of the reconciled ingredient before the ingredient is added to the batch. The stored program further measures and logs the quantity related to the origin container of the reconciled ingredient after the ingredient is added to the batch.

The foregoing and other objects and advantages of the invention will appear from the following description. In the description, reference is made to the accompanying drawings which form a part hereof, and which there is shown by way of illustration, a preferred embodiment of the invention. Such embodiment does not necessarily represent the full scope of the invention, however, and reference must therefore be made to the claims herein for interpreting the scope of the invention.

### BRIEF DESCRIPTION OF THE DRAWINGS

Reference is hereby made to the following figures in which like reference numerals correspond to like elements throughout, and in which:

FIG. 1 is a schematic view of a stand-alone commodity monitoring system constructed in accordance with the preferred embodiment of the invention;

FIG. 2 is a flowchart outlining the general operation of the commodity monitoring system illustrated in FIG. 1;

FIG. 3A is a flowchart illustrating steps for performing a stranded bucket process, illustrated in FIG. 2, in accordance with the preferred embodiment;

FIG. 3B is a flowchart illustrating additional steps for performing the stranded bucket process illustrated in FIG. 3A;

FIG. 3C is a flowchart illustrating additional steps for performing the stranded bucket process of FIG. 3A;

FIG. 3D is a flowchart illustrating additional steps for performing the stranded bucket process illustrated in FIG. 3A;

FIG. 4A is a flowchart illustrating steps for performing a reconciled ingredient setup for a single bucket process;

FIG. 4B is a flowchart illustrating additional steps for performing the reconciled ingredient setup for a single bucket process illustrated in FIG. 4A;

FIG. 5A is a flowchart illustrating steps for performing an unreconciled ingredient setup for a single bucket process;

FIG. 5B is a flowchart illustrating additional steps for performing the unreconciled ingredient setup for a single bucket illustrated in FIG. 5A;

FIG. 6A is a flowchart illustrating steps for weighing ingredients in a single bucket;

FIG. 6B is a flowchart illustrating additional steps for weighing the ingredients as illustrated in FIG. 6A;

FIG. 7A is a flowchart illustrating steps for performing a reconciled ingredient setup for multiple buckets process;

FIG. 7B is a flowchart illustrating steps for performing the reconciled ingredient setup for multiple buckets process illustrated in FIG. 7A;

FIG. 7C is a flowchart illustrating steps for performing the reconciled ingredient setup for multiple buckets process illustrated in FIG. 7A;

FIG. 8A is a flowchart illustrating steps for performing an unreconciled ingredient setup for multiple buckets process;

FIG. 8B is a flowchart illustrating steps for performing an unreconciled ingredient setup for multiple buckets process illustrated in FIG. 8A;

FIG. 8C is a flowchart illustrating steps for performing an unreconciled ingredient setup for multiple buckets process illustrated in FIG. 8A;

FIG. 9A is a flowchart illustrating steps for weighing ingredients in multiple buckets;

FIG. 9B is a flowchart illustrating additional steps for weighing the ingredients in multiple buckets as illustrated in FIG. 9A;

FIG. 10 is a schematic diagram of the commodity management system illustrated in FIG. 1 integrated into an automated batching system;

FIG. 11A is a display of the commodity monitoring station in “run” mode;

FIG. 11B is a display of the commodity monitoring station in “batches” mode;

FIG. 11C is a display of the commodity monitoring station in “ingredients” mode;

FIG. 11D is a display of the commodity monitoring station in “bags” mode;

FIG. 11E is a display of the commodity monitoring station in “buckets” mode; and

FIG. 11F is a display of the commodity monitoring station in “mixer” mode when the monitoring station is integrated into an automated batching system as illustrated in FIG. 10.

### DETAILED DESCRIPTION OF THE PREFERRED EMBODIMENT

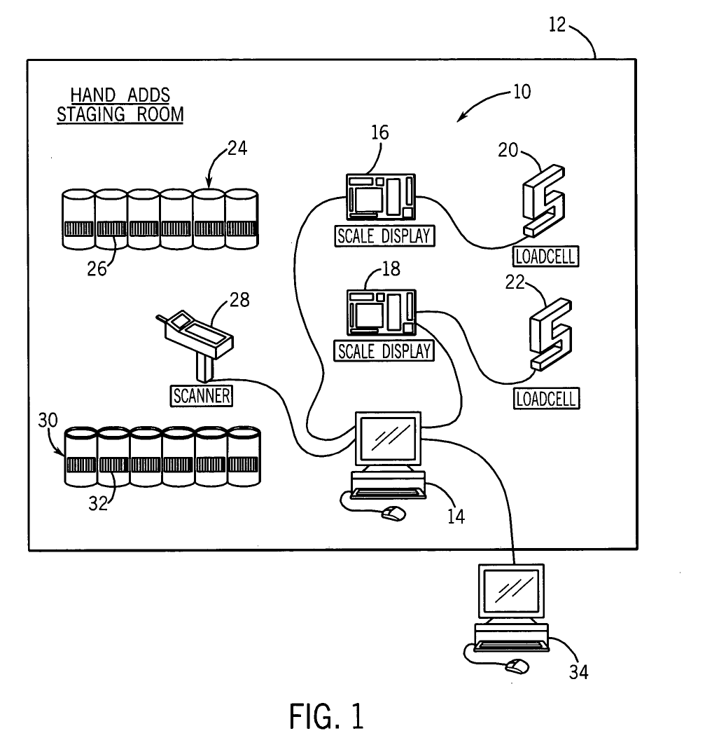

Referring initially to FIG. 1, a commodity monitoring system 10 is disposed in a hand-adding location 12 that is configured to enable controlled and uncontrolled ingredients to be hand added into a batch. Management system 10 includes a monitoring station 14, which may comprise any suitable PC or other dedicated apparatus capable of being programmed to monitor and track hand-added ingredients in accordance with any of the methods described below. Examples of commercially available monitoring stations include the Manual Commodity Execution System (MCES) available from Repete Corporation, located in Sussex, Wis. and the Short Mix System (SMS) available from Cargill, Inc., located in Minneapolis, Min.

Monitoring system 10 is illustrated in FIG. 1 as a stand-alone system, meaning that the monitoring system is not integrated with any other bulk batching operations. It should be appreciated that monitoring system 10 can be integrated with other batching systems, as will be described in more detail below.

Monitoring station 14 is connected to a first scale display 16 and optionally a second scale display 18. The first scale display 16 is connected to a first load cell 20, and optionally the second scale display 18 is connected to a second load cell 22. Accordingly, when an item is placed on either load cell 20 or 22, the corresponding weight will be displayed on its corresponding scale display 16 or 18 and forwarded to monitoring station 14. It should be appreciated in a single scale system, all weighing performed using second scale display 18 and load cell 22 would be replaced by first scale 16 and corresponding load cell 20.

A plurality of bags 24 (or origin containers) is provided, each of which containing a controlled or uncontrolled commodity. All controlled commodities are tracked by lot number, and are further reconciled. Certain uncontrolled commodities may also be reconciled, as described above, while the remaining uncontrolled commodities are unreconciled. Each bag of reconciled ingredients carries a bar code label having a bag-identifying bar code 26, though in some circumstances multiple bags of the same ingredient may have the same bar code. For instance, the same bar code can be present on bags containing uncontrolled reconciled ingredients which, accordingly, do not have associated lot numbers. Alternatively, if controlled ingredients associated with the same lot number have the same bar code, monitoring system 14 would verify both the bar code and the bag weight to verify that the correct bag is being used during a given production run.

Monitoring station 14 is further connected to a bar code scanner 28 for scanning the bar codes of each bag 26. The bag ingredients that are to be hand-added to a given batch are mixed in at least one of several buckets 30 (or transfer containers), each of which also carrying a bar code label having a unique bucket-identifying bar code 32. Accordingly, each bag 24 can be scanned by scanner 28, and the information forwarded to monitoring station 14, which then verifies the identity of the particular commodity stored in the scanned bag that is to be added to the mix. Monitoring station 14 can further identify and record the lot number associated with a bag containing a controlled ingredient based on the bar code scan. The weight of the bag may also be obtained and verified, as will be described in more detail below. Likewise the bar code label 32 corresponding to a given bucket 30 receiving hand-added ingredients can be scanned by bar code scanner 28 to store the identity of the bucket 30 in the monitoring station 14, along with the identification and quantities of the stored ingredients in the bucket, for future use.

Load cell 22 and scale display 18 are intended, during use, to measure the weight of buckets that are to contain unreconciled commodities, while load cell 20 and corresponding scale display 16 are intended, during use, to measure the weight of bags containing reconciled commodities.

A monitoring station 14 is also coupled to an inventory monitoring station 34, which can comprise a traditional PC having a hard drive, memory, data entry device, and display, or can alternatively comprise any other suitable dedicated device. Monitoring station 34 can be disposed at the hand added location, or more preferably can be remotely connected to the short mix station 14 and disposed in, for example, an executive office. New bags 24 of commodities are logged into inventory monitoring station 34 via bar code labels 26. Inventory monitoring station 34 thus tracks all incoming commodities disposed in bags 24 as well as the amounts of the various commodities that are used during operation of the commodity monitoring system.

Inventory monitoring station 34 can therefore provide inventory status updates to the commodity monitoring station 14 and an operator, and can further provide alerts when the inventory of a given commodity is low. Monitoring station 34 thus keeps track of all incoming commodities disposed in bags 24 as well as the amounts of the various commodities that are used during operation of the commodity monitoring system.

Monitoring System Display Screens and Modes

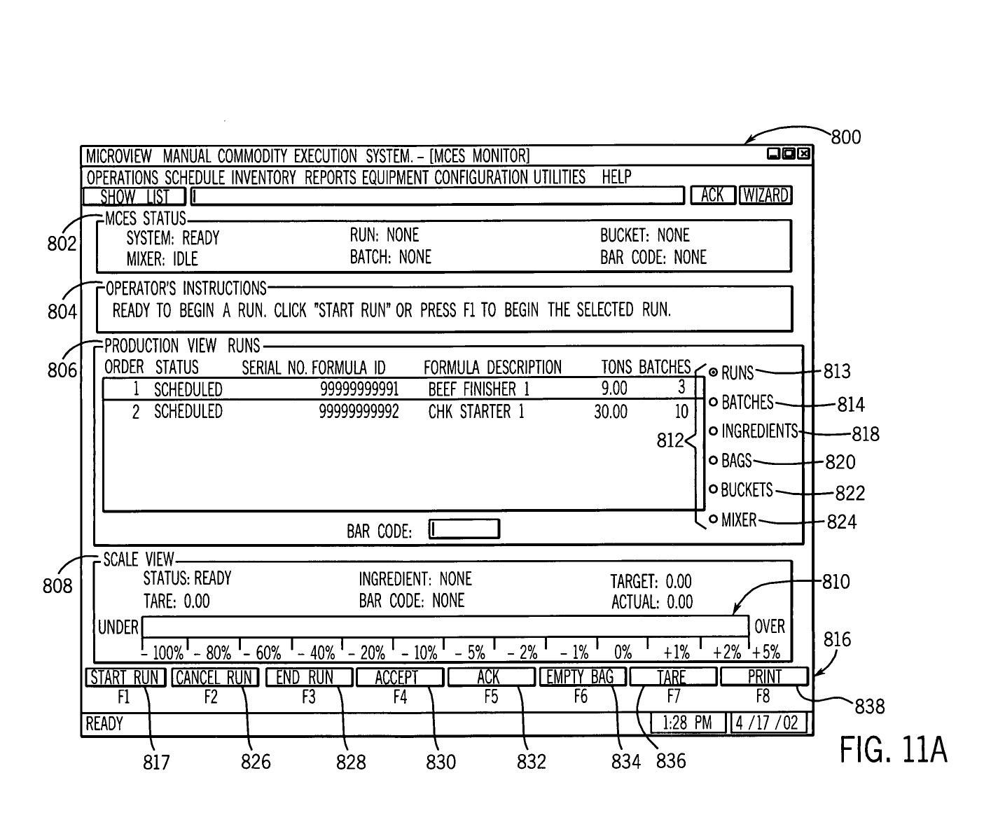

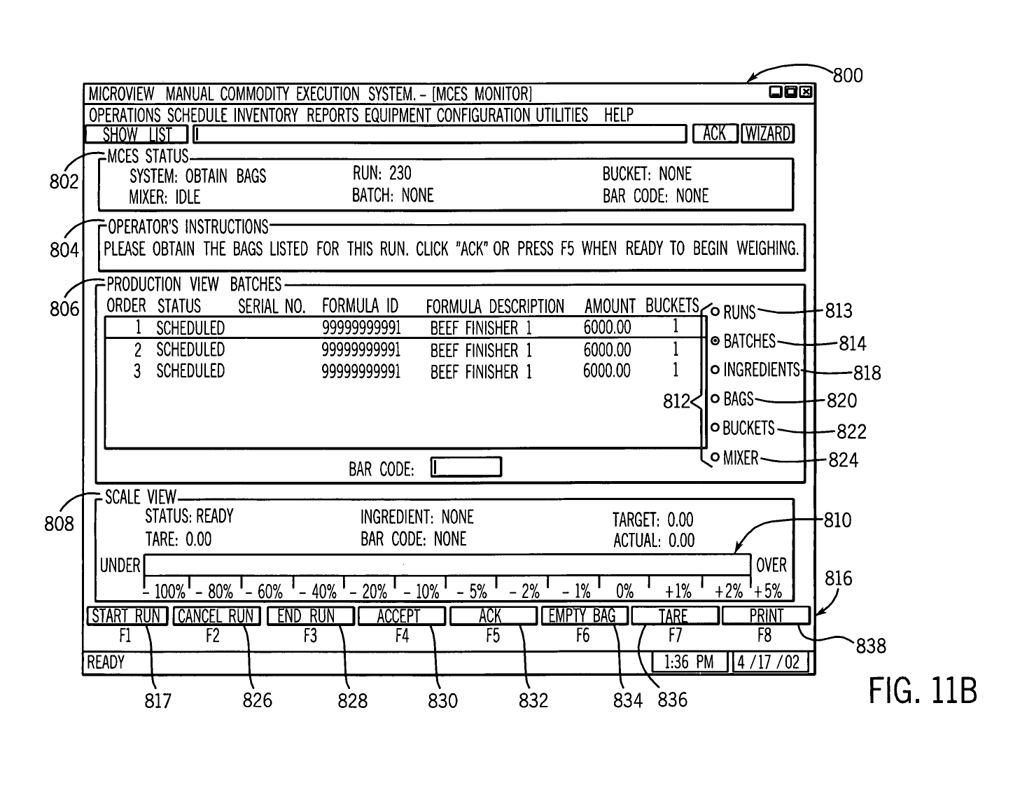

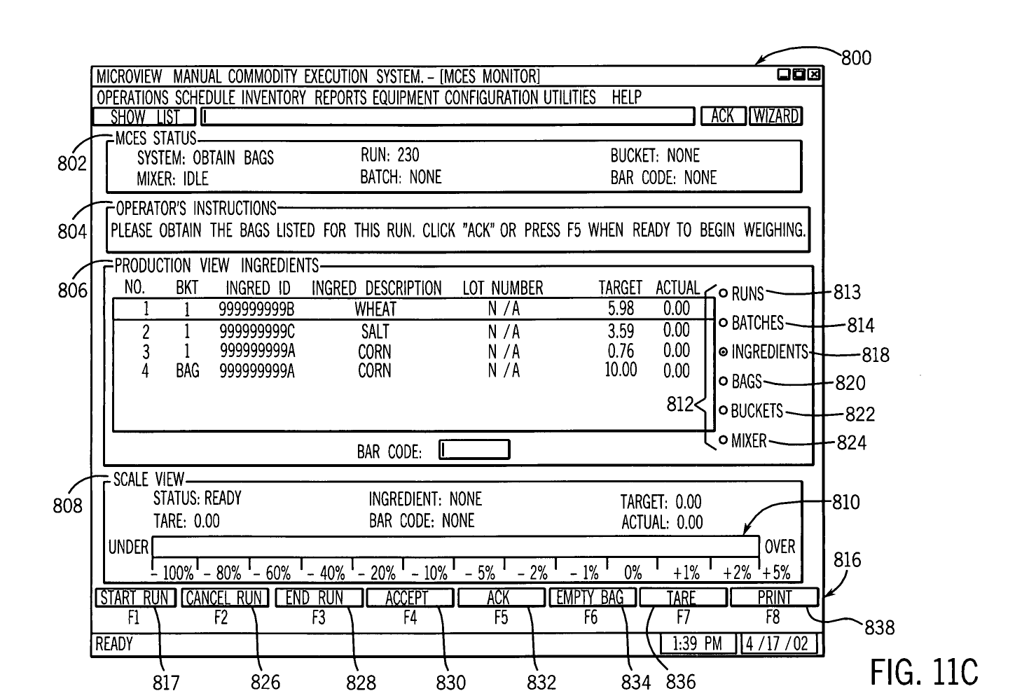

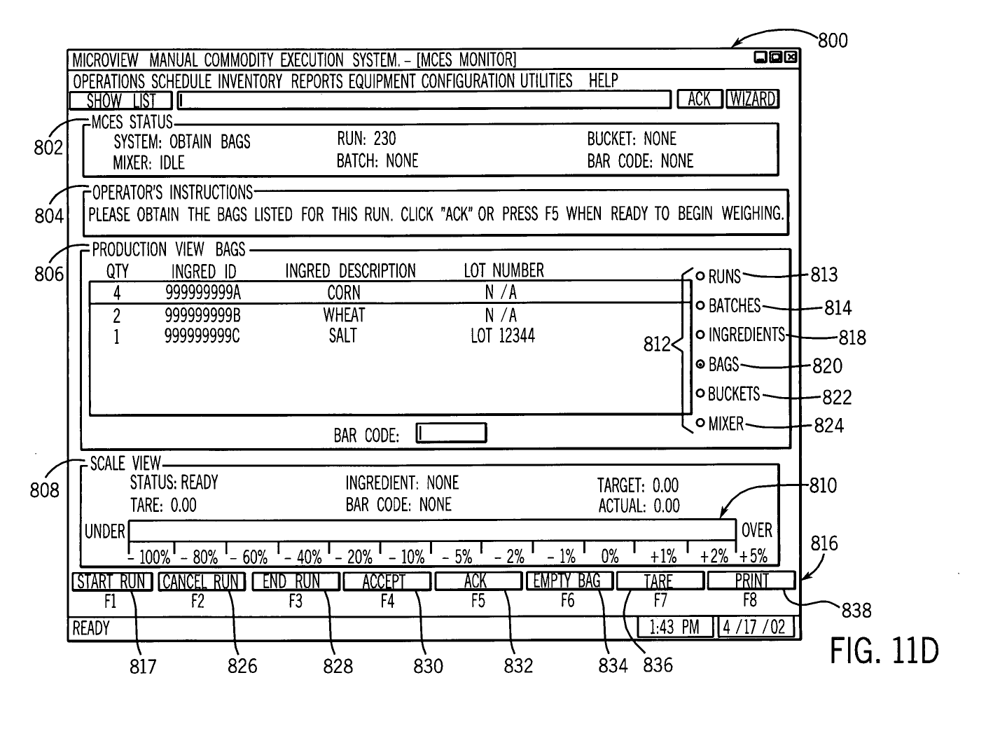

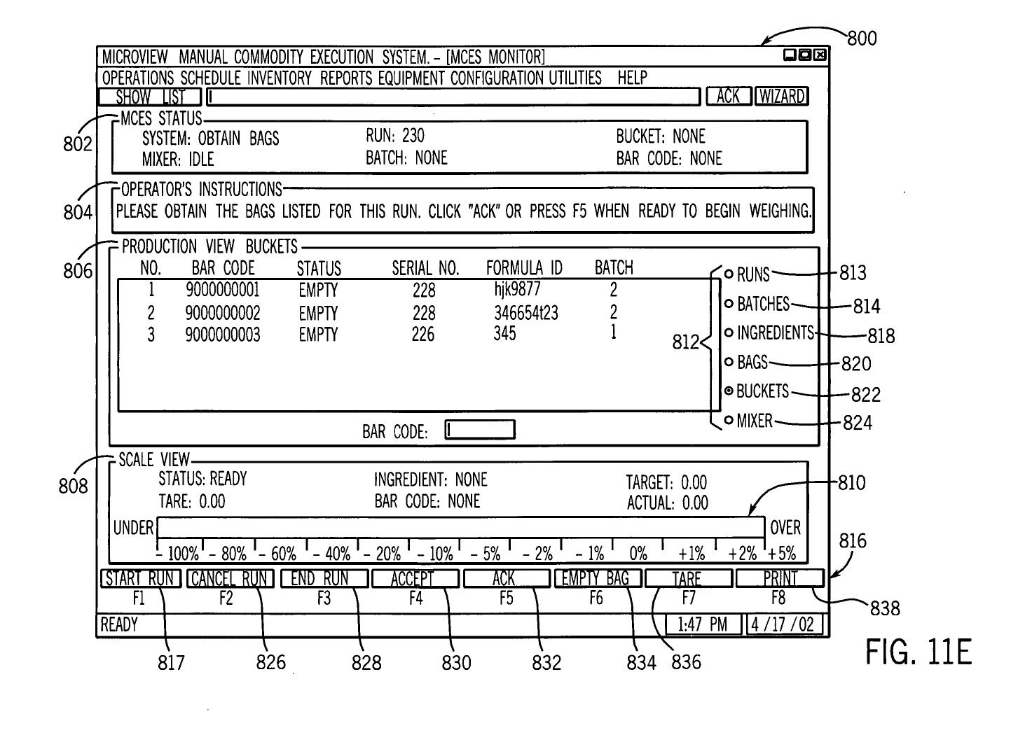

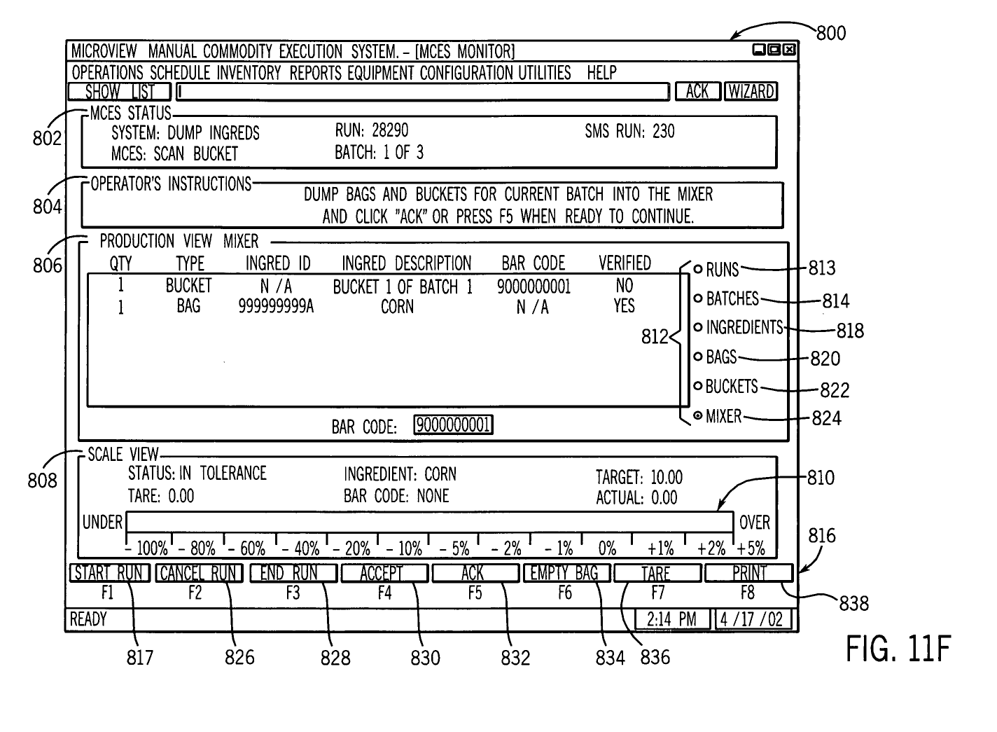

Prior to describing the method of system 10 in accordance with the preferred embodiment, the various screens displayed by the commodity monitoring station 14 will first be described with reference to FIGS. 11A-E. Referring in particular to FIG. 11A, the monitoring station 14 display 800 is divided into four regions. The first region 802 is a Status region that provides a status update to the operator. The status region 802 further identifies the number of the run in progress, the number of the batch in progress, and both the number and bar code of the bucket into which ingredients are being weighed for the current batch. Each production run is programmed into monitoring station 14. A “run” may include one or more “batches” of ingredients. Each batch may include ingredients that are disposed in one or multiple buckets. It should be appreciated that whole bags containing unreconciled ingredients that are to be added to a batch need not be placed into a bucket. Commodity station 10 enables an operator to complete a run one batch at a time, or alternatively to perform multiple batches simultaneously during a given run. The multiple batches are referred to herein as “groups.”

The second region 804 is an “Operator's Instructions” region that provides the operator with instructions that step the operator through the production of a hand-added batch. The third region 806 is a “Production View” region that provides the operator with various views of either the run currently in progress or of any run that is on the production schedule. The fourth region 808 is the “Scale View” region that provides scale information to the user. In particular, the “Scale View” region includes a weighing bar graph 810 that assists the operator in weighing hand-added ingredients.

One of various modes 812 within the production view region 806 may be selected using a conventional mouse or other data entry device associated with commodity monitoring station 14. FIG. 11A illustrates the display when the “run” mode 813 is selected. A series of user interface buttons 816 is provided at the bottom of the display 800, each of which can be selected using a predetermined keystroke or by clicking the associated screen icon using a conventional mouse.

The first button is a “Start Run” button 817 that enables the user to begin producing the batches associated with the current run. If the start of the run fails for any reason, monitoring station 14 will return the selected run to a “scheduled” state.

The “Cancel Run” button 826 may be selected using a predetermined keystroke or by clicking the screen icon with the mouse. Button 826 will initiate a sequence whereby the run is cancelled. In particular, the operator is prompted to confirm that the current run is to be cancelled. If the run is cancelled, monitoring station 14 will update the status of all buckets associated with the cancelled run as “stranded.” Stranded buckets can be allocated and added to subsequent batches, as will be described in more detail below.

When the “end run” button 828 is selected, the operator is prompted to confirm that the run is to be ended. If so, the operator is prompted to choose the last batch of the run that will be completed before ending the run. The “end run” procedure thus alters the total number of batches produced by the run, but does not create stranded buckets.

When the “accept” button 830 is activated, monitoring station 14 will accept that the weight of ingredient being added is within a predetermined range of a target weight, and proceed to the next step in the ingredient weighing routine. The “ack” button 832 is depressed to acknowledge compliance with the most recent request of monitoring station 14. The “empty bag” button 834 is pressed to initiate a sequence when the bag is emptied. The operator is then prompted to confirm that the bag is empty and a new bag is desired. The operator is then prompted to place a new bag on the appropriate scale and scan the new bar code label corresponding to the new bag. Monitoring station 14 will then confirm the new bar code label, as will be described in more detail below.

The “tare” button 836 us activated to initiate a tare of the scale reading. The “print” button 838 is activated to initiate a sequence whereby a printed report is generated. In particular, once the operator confirms that a report is desired, the system will print a report corresponding to one of the modes 812, as desired by the operator. If station 14 is in a “buckets” mode 822, as will be described in more detail below, monitoring station 14 will print a status report for buckets and a status report for stranded buckets.

Referring now to FIG. 11B, once button 817 is selected by the operator, the operator can also select “Batch” mode 814 in the “Production View” region 806 of display 800 to obtain the status, serial number, formula code and description, the amount, and the number of buckets required for each batch. The method used by monitoring station 14 to determine this information will be described in more detail below. In the example illustrated in FIG. 11B, the “Status” region 802 illustrates that the system is ready for the operator to obtain the bags of the ingredients to be used during the upcoming production run. The “Operator's Instructions” region 804 prompts the operator to obtain the bags containing the ingredients necessary for the upcoming production run. Once the bags are obtained, the operator can press the “acknowledge” button 832.

Referring now to FIG. 11C, when the operator selects the “ingredients” mode 818, the monitoring station 14 will display the bucket number, the ingredient code and description, the bar code of the bucket containing the ingredient, the target amount of the ingredient to be added, and the actual amount of each ingredient that was added.

Referring to FIG. 11D, when the operator selects the “bags” mode 820, the monitoring station 14 will display the bags required (both whole and partial) for the run in progress. The quantity of bags (a “P” will be provided if only a portion of a given bag is needed), the ingredient bar code, description of the ingredient, and lot number (if applicable) will be displayed. Multiple bags of the same ingredient bearing the same bar code are displayed on the same line in the “Production View” region 806. Multiple bags of the same ingredient bearing different bar codes will be displayed on different lines.

Referring to FIG. 11E, the operator can also select the “buckets” mode 822 in “Production View” region 806. Accordingly, all buckets currently defined in the system will be displayed along with the bar code of each bucket, status of bucket, serial number of bucket, the formula code, and batch number for the ingredients in the bucket. It should be appreciated that the data regarding the serial number, formula, and batch number pertain to the ingredients that were added to the bucket during a previous run. The status of each bucket programmed into the system is also displayed. For instance, if a bucket contains no ingredients, the status of the bucket will be “empty.” If a bucket is currently being filled with ingredients for a batch in a production run, the status of the bucket will be “in progress.” If a bucket has been filled with ingredients for a batch in a production run, the status of the bucket will be “complete.” Finally, if a bucket has been filled with ingredients from a previous production run that has since been canceled, the status of the bucket will be “stranded.”

A “mixer” mode 824 is also provided and may be selected when monitoring system 10 is integrated with an automated bulk ingredient batching system, as will be described in more detail below with reference to FIG. 11F.

General Method for Operating the Monitoring System

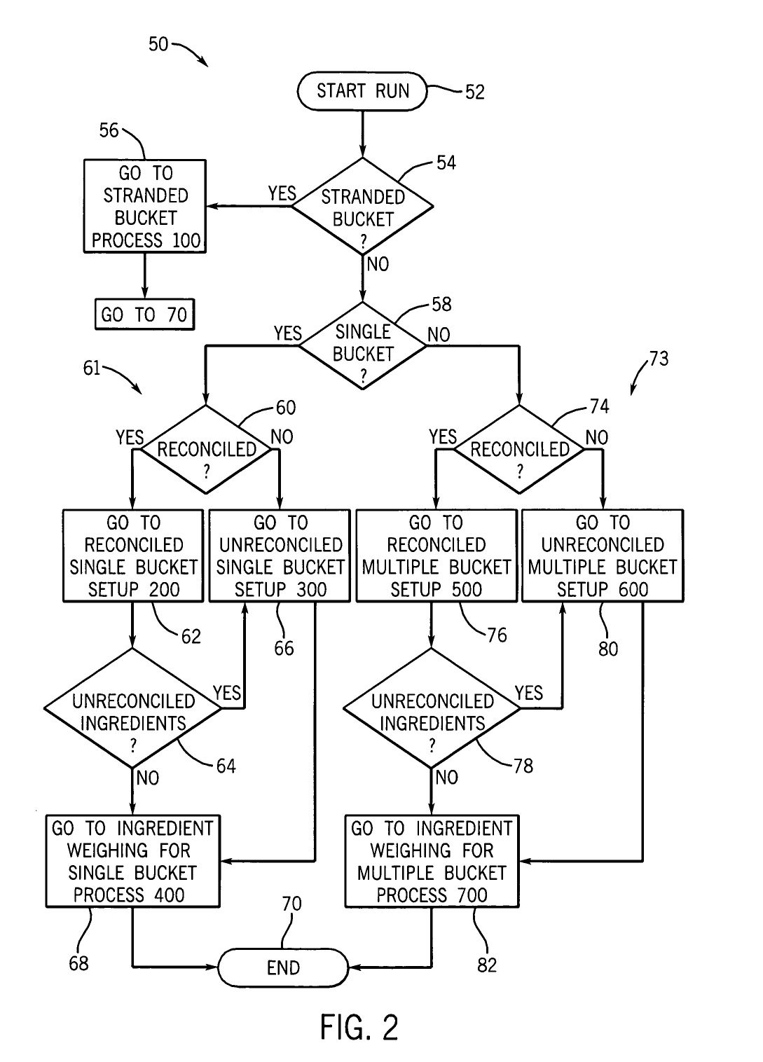

Referring now to FIG. 2, a method 50 for operating commodity monitoring system 10 begins at step 52. Once a run is programmed into monitoring station 14 and the operator selects the “Start Run” button 817, the monitoring station determines whether a stranded bucket is to be used in the current run at decision block 54. If a stranded bucket is to be used during the current production run, process 50 continues to step 56 to perform a stranded bucket routine 100. Once the routine 100 is finished, process 50 ends at step 70. If, however, the monitoring station 14 determines at decision block 54 that no stranded buckets will be used, process 50 continues to decision block 58. Monitoring station 14 determines at decision block 58 whether a single bucket process 61 or a multiple bucket process 73 will be performed.

The single bucket process 61 is suitable for preparing multiple batches of a production run with only one bucket on the scale at a time. In some instances, however, it may be desirable, especially when performing a large number of batches for a given production run, to place multiple buckets on either scale 20 or scale 22 to enable multiple batches to be prepared simultaneously. Some users may desire the timesaving ability of the multiple bucket process 73, while others may prefer the simplicity of a single bucket process 61. The operator can configure the monitoring station 14 accordingly.

If the single bucket process 61 is selected, method 50 proceeds to decision block 60, where the monitoring station 14 determines whether reconciled ingredients are going to be added during the current run. If so, monitoring station 14 executes a reconciled single bucket setup routine 200 at step 62. Once routine 200 has been completed, monitoring station 14 determines at decision block 64 whether unreconciled ingredients are also going to be added to the current production run. If not, monitoring station 14 executes an ingredient weighing for single bucket routine 400 at step 68. If the monitoring station 14 determines at decision block 64 that the current run contains unreconciled ingredients, or if monitoring station 14 determines at decision block 60 that no reconciled ingredients are going to be added in the current run, process 50 continues to step 66. Monitoring station 14 executes an unreconciled single bucket setup routine 300 at step 66 before continuing to step 68. Routine 50 then ends at step 70

If, on the other hand, the multiple bucket process 73 is to be executed as determined at decision block 58, routine 50 continues to decision block 74, whereby monitoring station 14 determines whether reconciled ingredients are going to be added during the current run. If so, monitoring station 14 executes a reconciled multiple bucket setup routine 500 at step 76. Once routine 500 has been completed, monitoring station 14 determines at decision block 78 whether unreconciled ingredients are also going to be added to the current production run. If not, monitoring station 14 executes an ingredient weighing for multiple bucket routine 700 at step 82. If the monitoring station 14 determines at decision block 78 that the current run contains unreconciled ingredients, or if monitoring station 14 determines at decision block 74 that no reconciled ingredients are going to be added in the current run, process 50 continues to step 80. Monitoring station 14 executes an unreconciled multiple bucket setup routine 600 at step 80 before continuing to step 82. Routine 50 then ends at step 70.

It should be appreciated that monitoring system 14 can prompt the operator to log in using a unique operator-identifying code, such as a log-in name and password prior to performing any steps in accordance with the present invention. It should furthermore be appreciated throughout the description below that reconciled ingredients that are added to the batch are initially provided in-bulk in a plurality of bags. The bags are stored in a dedicated facility configured to prevent unauthorized removal of the ingredient from the bags. The bags are only removed from the facility as needed, e.g., when the corresponding ingredient is to be added to a batch, and are returned to the facility once the production run is completed. Accordingly, an individual may be held accountable if the monitoring station 14 determines that a quantity of an ingredient is unaccounted for.

The operation of the stranded bucket routine 100, single bucket process 61, and multiple bucket process 73 will now be described.

Stranded Bucket Routine

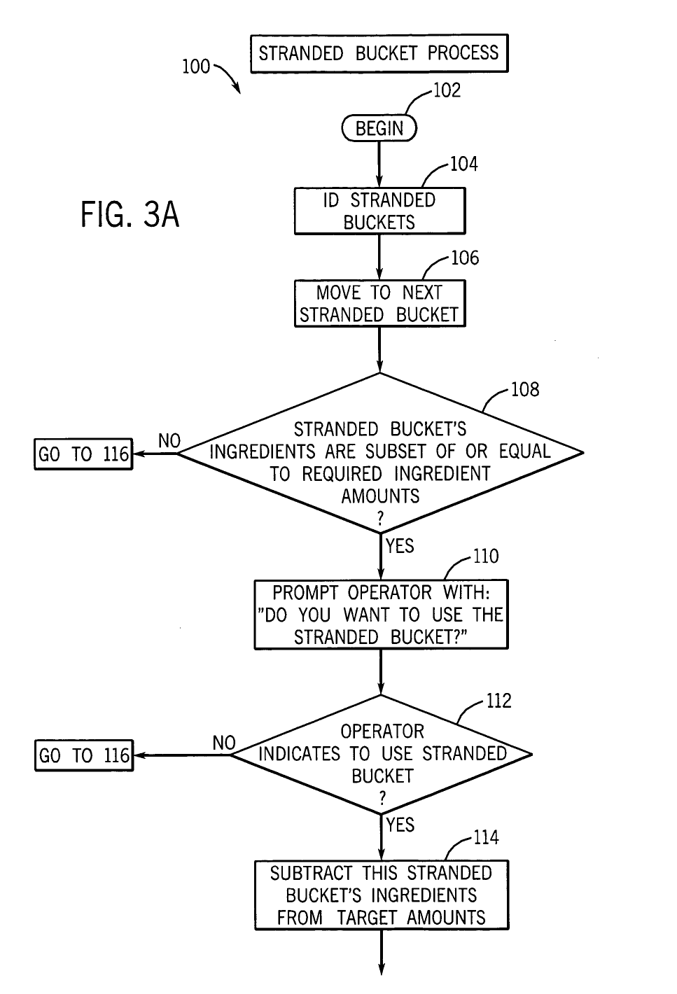

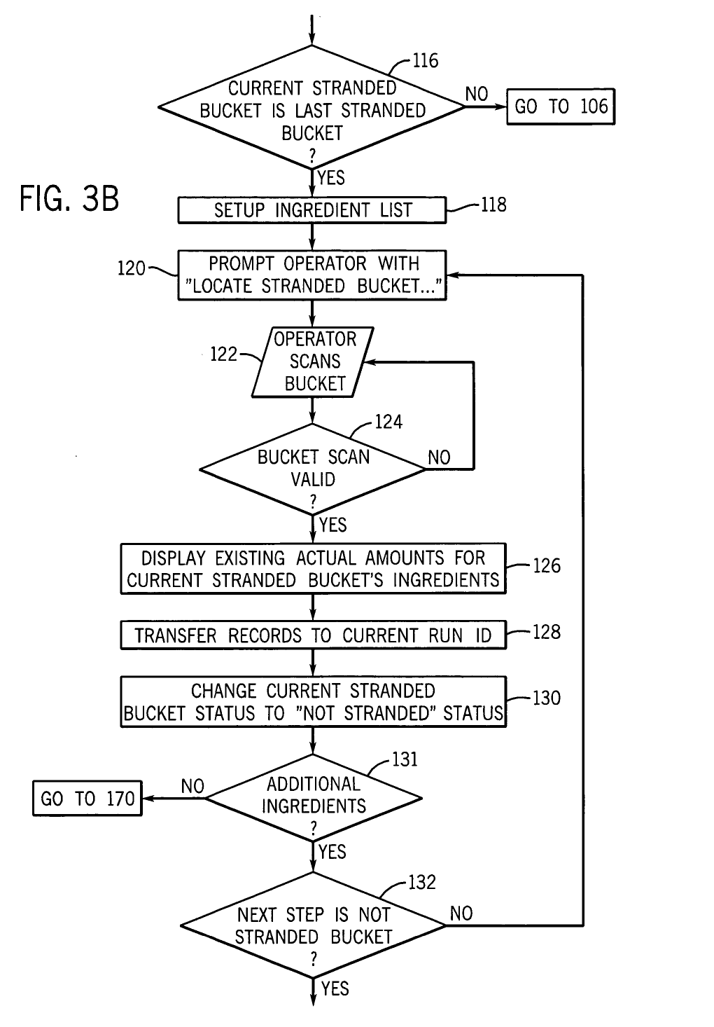

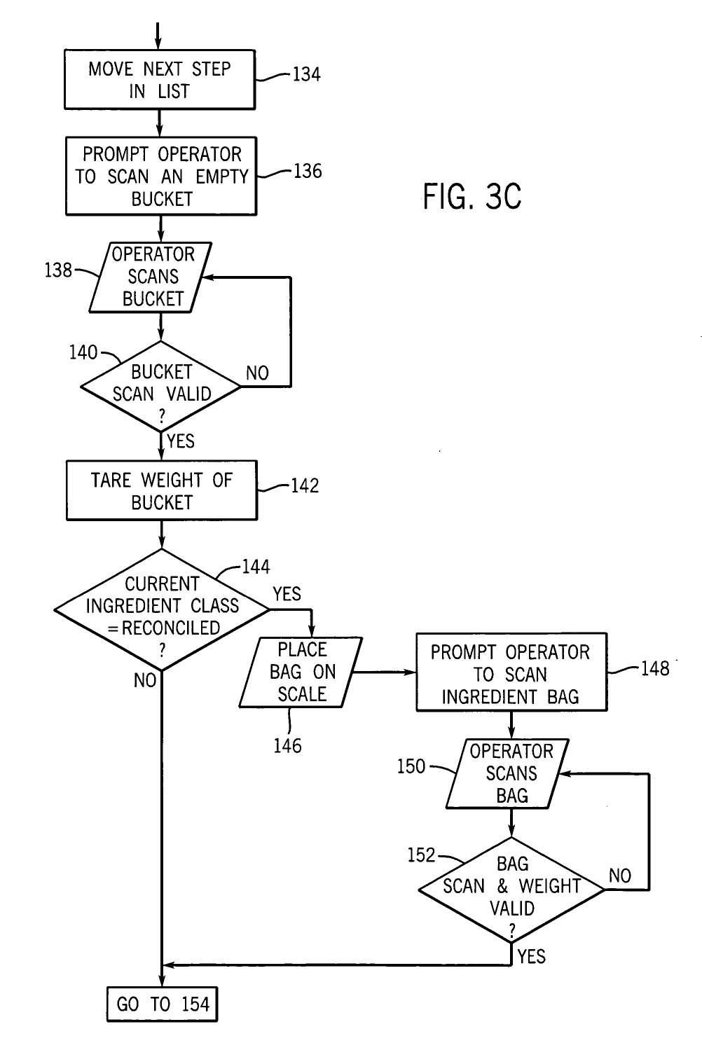

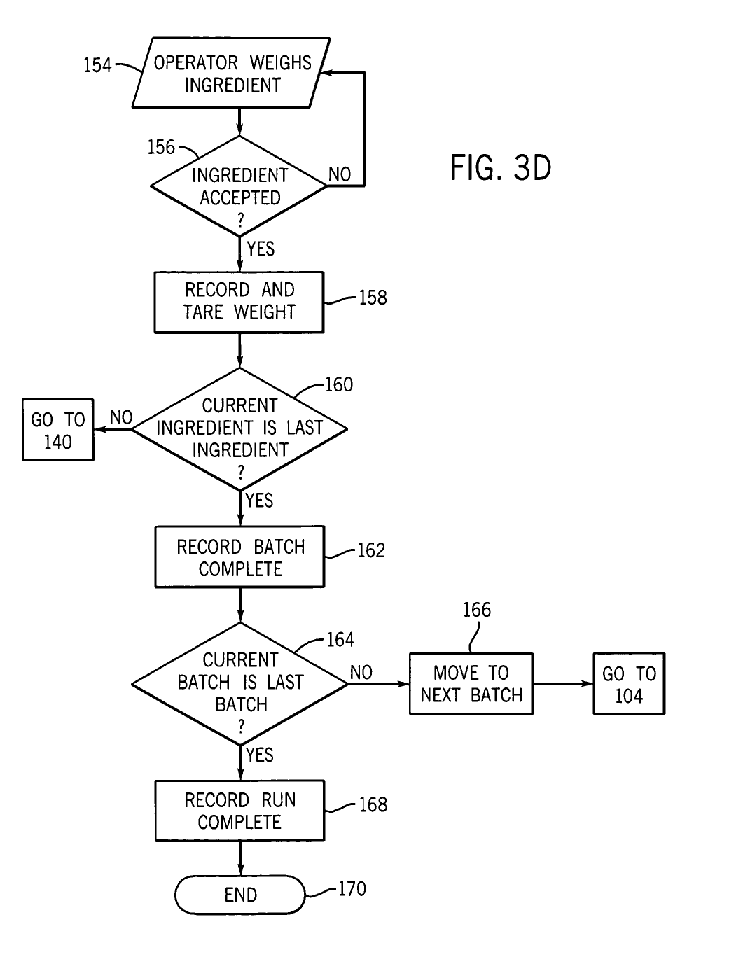

In particular, referring now to FIG. 3A, the stranded bucket routine 100 begins at step 102 and proceeds to step 104, whereby the monitoring station 14 identifies all stranded buckets from previously cancelled production runs. Next, at step 106, monitoring station 14 identifies to the next stranded bucket, which is the first stranded bucket during the first iteration of routine 100. Next, at step 108, monitoring station determines whether the quantity of ingredients in the stranded bucket identified at step 106 are either a subset of, or equal to, the required ingredient quantities for the current batch. If not, routine 100 proceeds to decision block 116, where it is determined whether the current stranded bucket is the last of the stranded buckets identified at step 104. If so, routine 100 continues to step 118, as will be described in more detail below. If the current stranded bucket is not the last stranded bucket, routine 100 reverts to step 106, where the next stranded bucket is identified.

Referring again to decision block 108, if the stranded buckets ingredients are either a subset of, or equal to, the required ingredient amounts, routine 100 continues to step 110. At step 110, monitoring station 14 prompts the operator to determine whether or not to use the identified stranded bucket for the current batch. Next, at decision block 112, if the operator does not wish to use the current stranded bucket, routine 100 continues to decision block 116 as described above. If the operator does desire to use the current stranded bucket, monitoring station 14 subtracts the ingredients in the stranded bucket from the target amounts calculated for the current batch at step 114. Steps 106 through decision block 116 are continued until all stranded buckets to be used in the current batch have been identified. It should thus be appreciated that steps 104-116 constitute a “stranded bucket setup” routine in preparation for the addition of the ingredients disposed in the stranded buckets to the current production batch.

Once the last stranded bucket has been identified at decision block 116, commodity monitoring station 14 sets up the ingredient list for the current batch at step 118, and prompts the operator to locate a particular stranded bucket at step 120. It should be appreciated that monitoring station 14 determines whether any ingredients are to be split, meaning whether the quantity of any ingredients exceeds the available volume of an empty bucket. If so, monitoring station 14 executes a stranded bucket process that will be described in more detail below with reference to setup routines 200 and 500.

Next, at step 122, the operator scans the bar code of the next stranded bucket to be used, which is initially the first stranded bucket. Decision block 124 verifies that the bucket scan is valid, at which point monitoring station 14 displays the existing amounts for the current stranded buckets ingredients. It should be noted that the monitoring station 114 has previously stored the amounts and ingredients of the current stranded bucket from the previous production run that was canceled. Next, at step 128, commodity monitoring station 14 transfers the records corresponding to the current stranded bucket to the current batch. In particular, the identification code corresponding to the stranded bucket bar code label 32, along with the ingredients and quantities of the ingredients to be added are electronically recorded and assigned to the current batch. Next, at step 130, the status of the current bucket is changed from “stranded” to an “in progress” status that indicates the bucket is not stranded.

Next, at decision block 131, monitoring station 14 determines whether any additional ingredients are to be added to the current batch. If not, routine 100 ends at step 170. If additional ingredients are to be added to the current batch, routine 100 proceeds to decision block 132, which ensures that steps 120-130 are repeated for each stranded bucket to be used in the current batch. If ingredients remain to be added as determined at decision block 131, and all stranded ingredients have already been added as determined at decision block 132, routine 100 continues to step 134, whereby monitoring station 14 identifies the next ingredient in the ingredient list that has not yet been fully accounted for by the stranded buckets. For instance, certain ingredients may not have been present in any of the stranded buckets, or the quantity of a given ingredient in a stranded bucket may have been less than the desired amount for that particular ingredient for the current batch.

The operator is then prompted at step 136 to scan an empty bucket. At step 138, the bucket is scanned and the bucket scan is validated at decision block 140. The bucket is then placed on scale 22, and the weight of the empty bucket is tared by monitoring station 14 at step 142. Next, at decision block 144, monitoring station 14 determines whether the current ingredient to be added is a reconciled ingredient.

If the ingredient is a reconciled ingredient, the operator places the bag containing the reconciled ingredient on scale 20 at step 146. Next, at step 148, monitoring station 14 prompts the operator to scan the bar code label of the bag containing the current ingredient that is to be added to the batch. The operator then scans the bar code of the bag at step 150 using scanner 28. Monitoring station 14 then determines whether the bag scan is valid. The bag will be validated if 1) the bag contains the correct ingredient, and 2) the weight of the bag corresponds to the weight of the bag stored in monitoring station 14. The bag weight will be verified if 1) if the bag is new and the weight of the bag equals (or is within a predetermined tolerance of) an unused bag, or 2) if the bag is used and the weight of the bag equals (or is within a predetermined tolerance of) the weight of the bag after that was recorded after the bag was used in a previous production run. It should be appreciated throughout the description below that monitoring station 14 can activate an error signal if a bag weight can not be verified.

Once the bag containing the reconciled ingredient is verified, routine 100 proceeds to step 154, whereby the operator transfers ingredient from the previously weighed bag into the bucket that was scanned at step 138. The weight of the bag is continuously monitored and the amount removed from the bag is displayed to the operator via bar graph 810. Once the target quantity of ingredient has been removed from the bag, the ingredient will be accepted at decision block 156, at which point the new weight of the bag will be recorded and tared at step 158.

It should be appreciated that, because monitoring station 14 continuously verifies the quantity of reconciled ingredient being removed from the bag, the monitoring station need not measure the quantity of reconciled ingredient being added to the bucket. Accordingly, the bucket need not be on a scale while reconciled ingredients are being added in accordance with the preferred embodiment of the invention. However, in accordance with an alternate embodiment, the bucket could also be on a scale, which would enable the monitoring station 14 to verify that all quantities of reconciled ingredient that are removed from the bag are being added to the bucket.

If, on the other hand, the ingredient to be added is an unreconciled ingredient as determined at decision block 144, process 100 proceeds directly to step 154, whereby the unreconciled ingredient is added to the bucket, which is still disposed on scale 22. Monitoring station 14 continuously weighs the bucket as ingredient is added, and conveys the weight of added ingredient to the operator via bar graph 810. Once the target weight of ingredient has been added as determined at decision block 156, process 100 proceeds to step 158, whereby the quantity of the ingredient added to the bucket is recorded and the weight of the bucket is tared.

Next, at decision block 160 monitoring station 14 determines whether the most recently added ingredient was the last ingredient. If not, and additional ingredients remain to be added to the current batch as determined at decision block 160, process 100 reverts to step 140, whereby a bucket is filled with additional ingredients. It should be appreciated that, if desired, quantities of additional ingredients may be split into multiple buckets, including the remaining volume of the bucket that was used during the previous iteration, as will be described in more detail below with reference to the single and multiple bucket processes.

If monitoring station 14 determines at decision block 160 that no more ingredients are to be added to the current batch, the batch is recorded as “complete” at step 162. Next, monitoring station 14 determines at step 164 whether the batch recorded at step 162 was the final batch in the production run. If not, monitoring station 14 initializes itself for an additional batch of the current production run at step 166, and repeats steps 104-164 for all additional batches until the last batch has been completed as determined at decision block 164. Once all batches have been completed, the run is recorded as being complete in monitoring station 168, and the process ends at step 170.

It should thus be appreciated that stranded bucket routine 100 enables a mixture of ingredients from stranded buckets and new ingredients to a batch. Furthermore, any reconciled ingredients in the stranded buckets will be recorded based on the validated addition of those ingredients to the stranded bucket during the previously canceled production run. Accordingly, a production run, including multiple batches of reconciled and unreconciled hand-added ingredient mixtures, is provided while complying with FDA regulations and avoiding the tedious manual reconciliation associated with the prior art. It should be appreciated that the stranded bucket routine 100 can be integrated with the multiple bucket routines 500, 600, and 700 to include the contents of stranded buckets into at least one of the multiple buckets, as will be appreciated by one having ordinary skill in the art from the description below.

Single Bucket Setup Routines

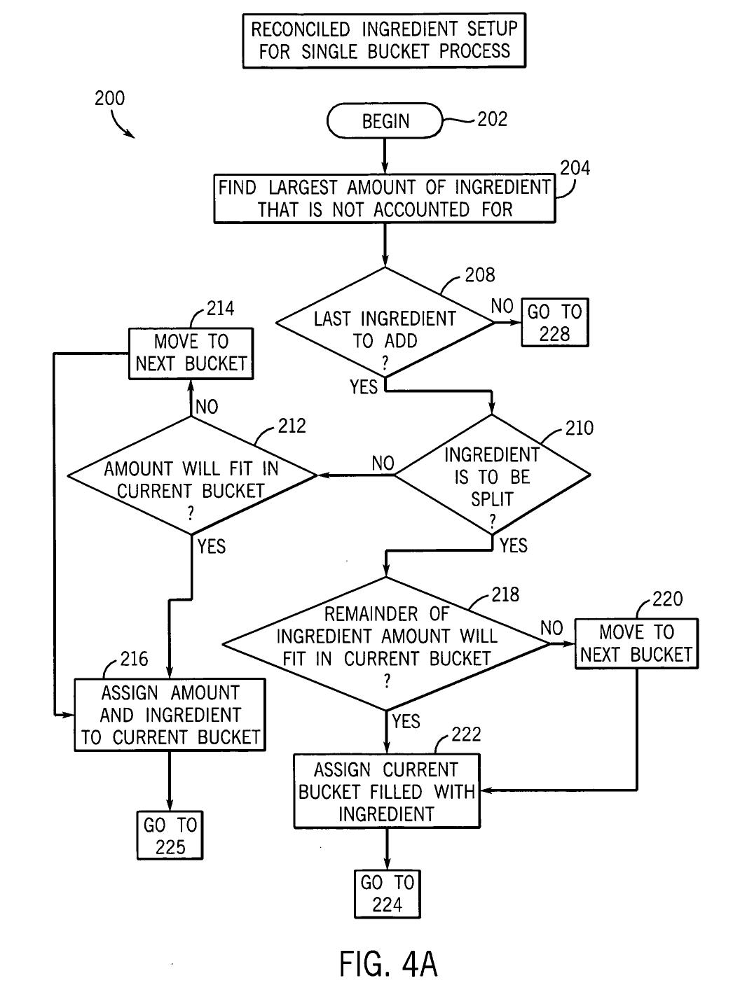

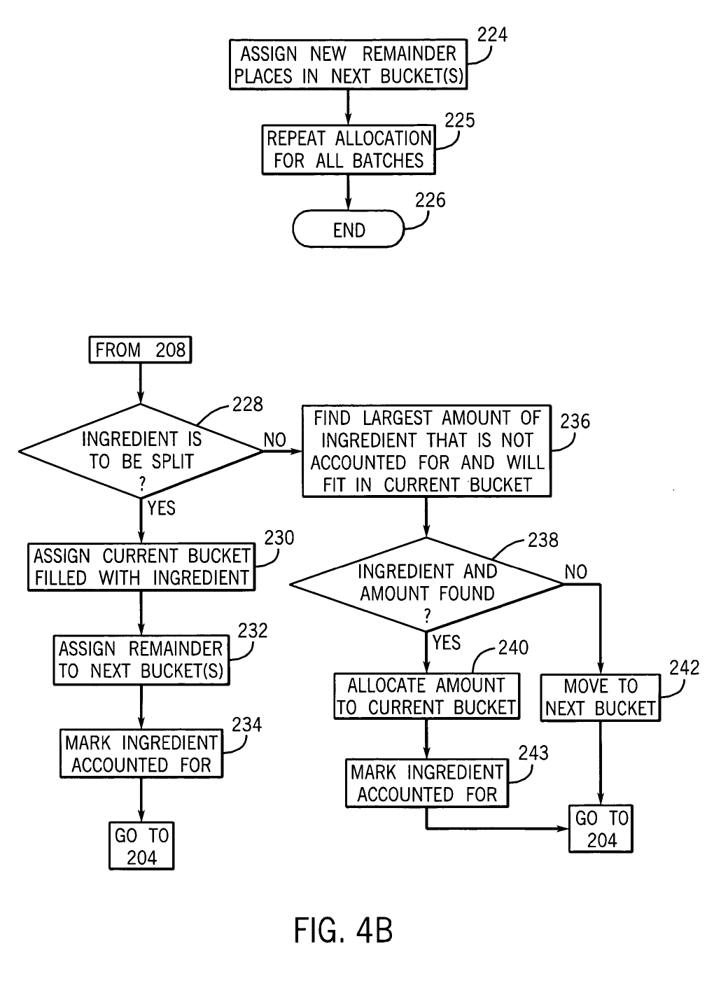

As described above with reference to FIG. 2, if a stranded bucket is not to be used at decision block 54, and if the monitoring station 14 is configured to add ingredients using the single bucket process 61, monitoring station 14 determines whether the current batch is going to use reconciled ingredients. If so, monitoring station 14 executes a reconciled ingredients set up for a single bucket routine 200, as will now be described with reference to FIGS. 4A-B.

In particular, routine 200 begins at step 202 and then proceeds to step 204, whereby monitoring station 14 identifies the ingredient, among all ingredients not yet allocated, that has the largest quantity to be added to the batch. Step 204 enables the hand-added ingredients to be mixed while minimizing the number of buckets required for a given batch, as will become apparent from the description below. If the ingredient identified at step 204 is the last ingredient to be added to the current batch, as determined at decision block 208, routine 200 proceeds to decision block 210.

Alternatively, if additional ingredients are to be added as determined at decision block 208, as is generally the case during the initial iteration, routine 200 proceeds to decision block 228. At decision block 228, monitoring station 14 determines whether the current ingredient to be added is to be split into more than one bucket. An ingredient will be deemed “split” if the quantity of that ingredient exceeds the available capacity of an empty bucket. If the ingredient is to be split, the remaining volume of the current bucket is reserved for the ingredient at step 230. The remaining quantity of the ingredient to be added to the current batch is allocated to an additional empty bucket or buckets, depending on the quantity of the remainder, at step 232. The last bucket will be partially filled, and will thus be used during the next iteration of routine 200. Once all quantity of the ingredient has been allocated, the ingredient is marked “accounted for” at step 234. Process then reverts to step 204.

If, on the other hand, the entire quantity of the current ingredient can fit into an empty bucket, monitoring station 14 determines the largest amount of all unallocated ingredients that will fit entirely into the current bucket at step 236. If no such ingredient exists, monitoring station 14 identifies a new empty bucket, and reverts to step 204 without marking the ingredient “accounted for.” It should be appreciated, if step 242 is performed in a given iteration of routine 200, that during the next iteration of routine 200, the ingredient identified in the previous iteration will be allocated to the bucket selected at step 242 of the previous iteration, as monitoring station has already determined that the ingredient will not be split.

If, on the other hand, monitoring station identifies an ingredient and amount that entirely fits into the volume available in the current bucket, which may or may not be the ingredient identified at step 204, the ingredient is allocated to the current bucket at step 240. That ingredient is also marked “accounted for” at step 243 prior to reverting to step 204.

Once process 200 reverts to step 204, monitoring station 14 again determines at decision block 208 whether the current ingredient is the last ingredient to be added for the current batch. If so, the process proceeds from decision block 208 to decision block 210 as described above, whereby the monitoring station 14 determines whether the last ingredient is to be split. If not, and the quantity of the last ingredient will fit into the current bucket as determined at decision block 212, the last ingredient is allocated to the current bucket at step 216. Otherwise, monitoring station allocates the last ingredient to a new, empty, bucket at step 216. Routine 200 then proceeds to step 225.

If, however, the quantity of the last ingredient to be added for the current batch is larger than the quantity of an empty bucket, process 200 will continue from decision block 210 to decision block 218. At decision block 218, monitoring station 14 divides the quantity of the last unallocated ingredient by available volume of an empty bucket, and calculates the quotient as a whole number having a remainder. Monitoring station 14 determines whether the remainder will fit into the current bucket at decision block 218. If so, the remainder of the ingredient is allocated into the current bucket at step 222. Next, at step 224, the new remainder (after the original remainder is subtracted at step 222) is allocated into as many buckets as necessary to consume the entire quantity of the last remaining ingredient.

If the remainder of the last ingredient will not fit into the current bucket as determined at decision block 218, monitoring station selects a new, empty, bucket at step 220, and assigns that bucket to be filled with the current ingredient. Next, at step 224, the remainder of the ingredient is allocated into as many buckets as necessary to ensure that the entire quantity of the last ingredient has been allocated. At step 225, monitoring station 14 repeats the allocations of routine 200 for the predetermined number batches of the current run. Routine 200 then ends at step 226.

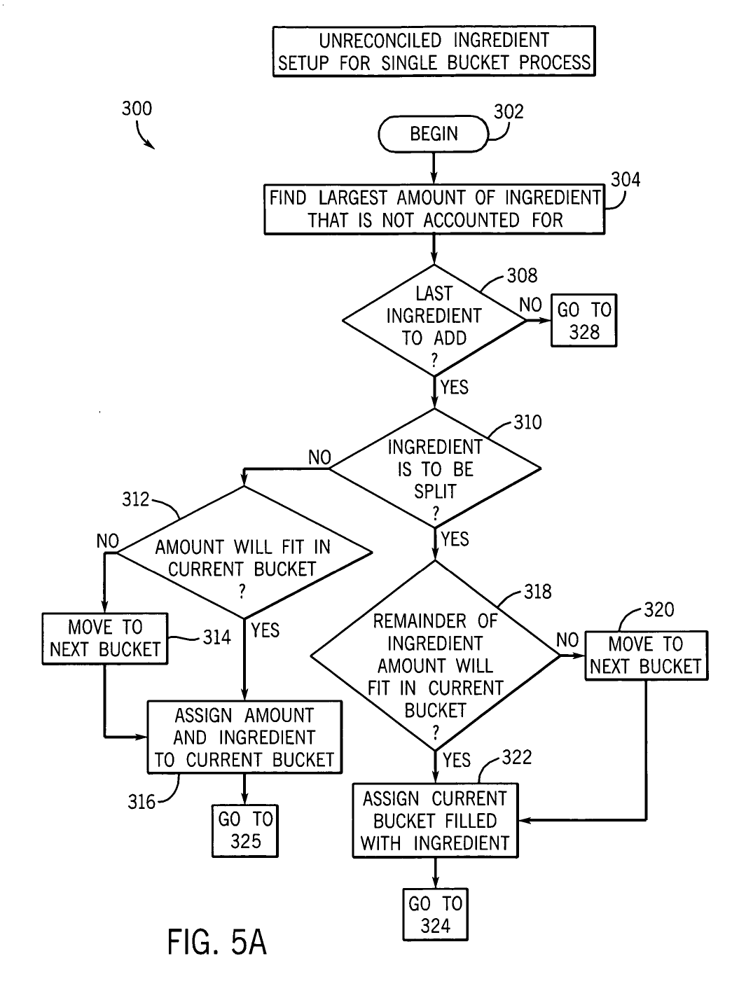

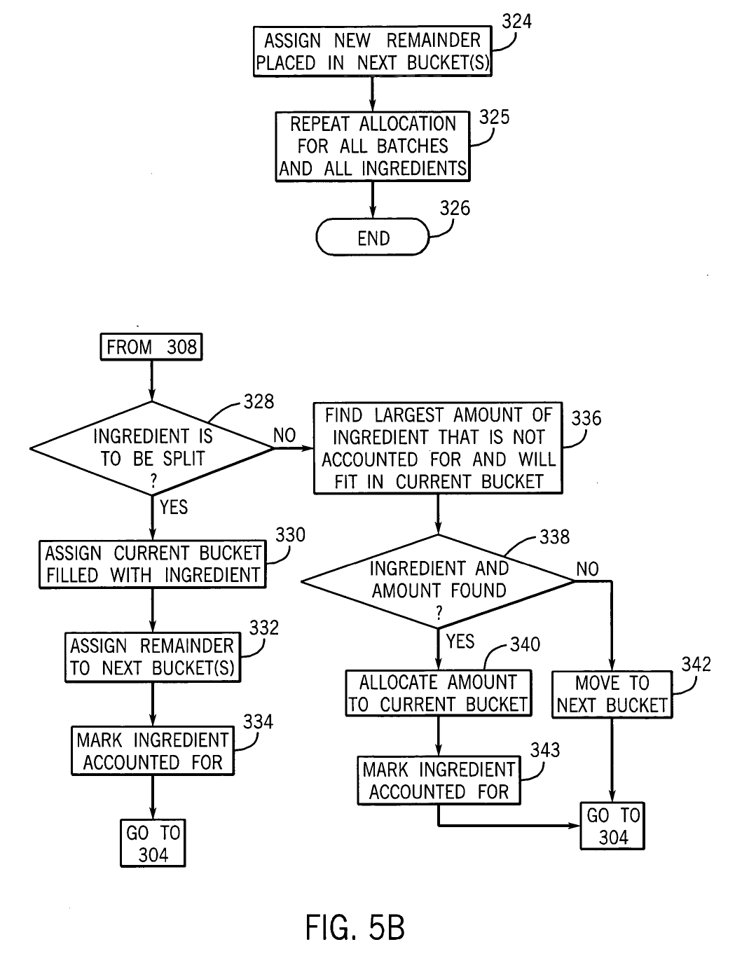

Referring again to FIG. 2, once reconciled single bucket setup routine 200 is complete, process 50 continues to decision block 64, whereby the monitoring station 14 determines whether any unreconciled ingredients are to be added to the current batch(es). If so, or if monitoring station 14 determines at decision block 60 that the current batch(es) will not contain any reconciled ingredients, monitoring station 14 executes an unreconciled single bucket setup 300 at step 66. In particular, the steps of routine 200 illustrated FIGS. 4A-4B have been incremented by 100 for routine 300 illustrated in FIGS. 5A-5B for the purposes of clarity and convenience. Accordingly, routine 300 is identical to routine 200, but for the fact that routine 300 is performed with reference to the unreconciled ingredients that are to be added to the batch(es) using the single bucket process 61. Accordingly, the steps of method 300 will not be described individually.

It should be appreciated that monitoring station 14 does not identify the specific buckets to be used for the various ingredients during setup routine 200 and 300, along with the other setup routines discussed in more detail below. Rather, the monitoring station 14 maps the proper sequence and quantities of ingredients that are to be added to a given bucket or buckets when the ingredients are mixed. Accordingly, when the ingredients are to be mixed in actual preparation of the batches, the operator will retrieve an empty bucket, and the monitoring station 14 will instruct the operator as to the proper quantity of the proper reconciled and unreconciled ingredient(s) that are to be placed into the bucket. In this regard, it should be appreciated that a given bucket will either contain reconciled ingredients or unreconciled ingredients or both, as reconciled ingredients are weighed first, but subsequently weighed unreconciled ingredients can be added to the same bucket that is partially filled with reconciled ingredients. The monitoring station will also prompt the operator as to the proper sequence in which the ingredients are to be added to the buckets, and when to change buckets before adding a given quantity of ingredient. Because each bucket used to fill ingredients is scanned, the monitoring station will be able to identify the mixture of ingredients based on the identification of the bucket. The single bucket weighing routine 400 will now be described.

Single Bucket Weighing Routine

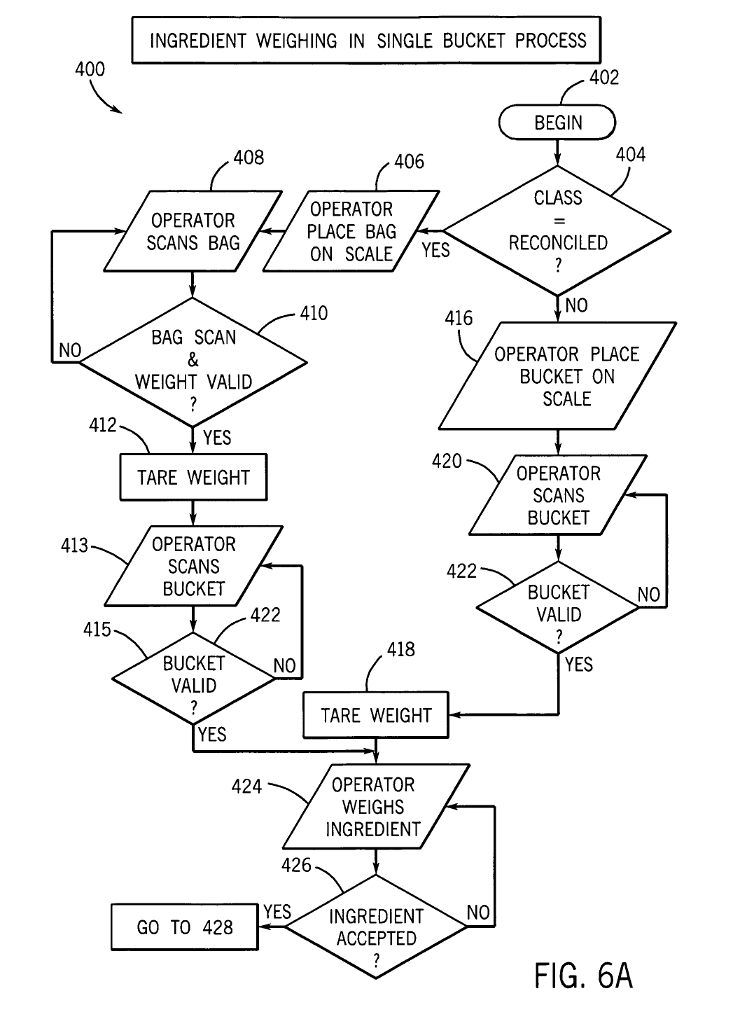

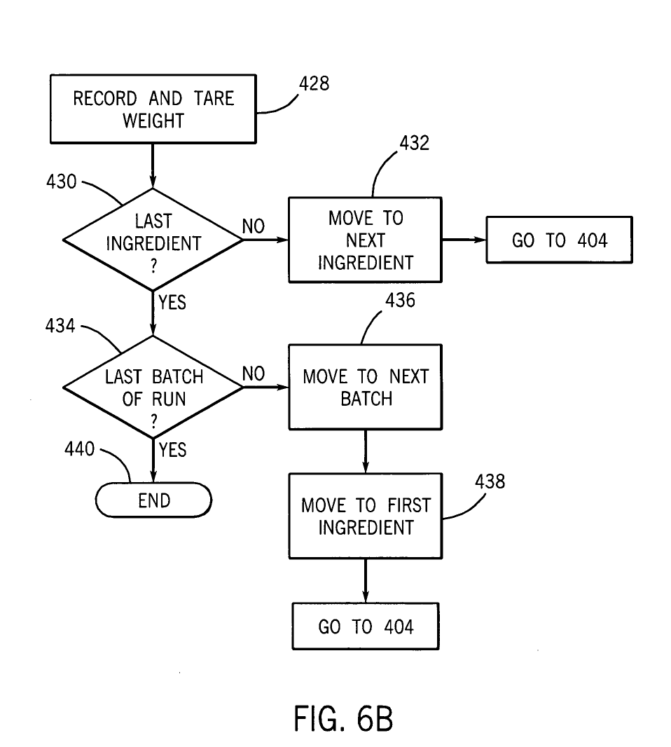

Next, referring again to FIG. 2, once both steps 62 and 66, if necessary, have been completed, process 50 continues to step 68, whereby the ingredients are weighed and mixed for the single bucket process 61 using routine 400, as will now be described with reference to FIGS. 6A-B. It should be appreciated that ingredients are added in the order and in the quantity that were predetermined using setup routines 200 and 300 described above.

In particular, routine 400 begins at step 402 and proceeds to decision block 404 where monitoring station 14 determines whether the current ingredient to be added is a reconciled ingredient. If so, the operator places the bag containing the ingredient to be added on the scale 20 at step 406. Next, at step 408, the operator scans the bar code label of the bag that was placed on the scale at step 406. Decision block 410 verifies, based on the bar code label, that the bag contains the correct ingredient that is to be added, and furthermore verifies that the weight of the bag is valid. Monitoring station 14 further verifies at decision block 410 that the correct lot is being used for controlled commodities. The weight of the bag will be deemed valid if 1) the bag is new and the weight of the bag equals (or is within a predetermined tolerance of) the weight of a new bag; or 2) the bag is used and the weight of the bag measured at step 406 equals (or is within a predetermined tolerance of) the previously recorded bag weight. Once the bag has been validated, monitoring station 14 tares the bag weight at step 412.

Next, at step 413, the operator is prompted to scan a bucket that is to be filled with the ingredient. During the first iteration of routine 400, the initially scanned bucket will be empty. The status of the bucket is validated by monitoring station at step 422. Next, at step 424, the operator begins filling the bucket with the first predetermined ingredient. As reconciled ingredient is removed from the bag and added to the bucket, the weight of the bag is constantly recorded by monitoring station 14 and the amount removed from the bag is displayed on bar graph 810. Once the target amount of the ingredient has been added, the ingredient is accepted at decision block 426, and the new weight of the bag is measured and recorded at step 428. The new bag weight is forwarded to inventory monitoring station 34 for future reference. Accordingly, when the bag is used during a subsequent batch or production run, the weight of the bag can be verified to account for all of the reconciled ingredient as mandated by the Food and Drug Administration. It should also be appreciated, in accordance with an alternate embodiment, the bucket could also be disposed on a scale while reconciled ingredient is added, which would enable the monitoring station 14 to verify that all quantities of reconciled ingredient that are removed from the bag are being added to the bucket. Current FDA regulations, however, only require that certain ingredients be reconciled, as described above.

If, on the other hand, the ingredient to be added is not a reconciled ingredient as determined at decision block 404, routine 400 proceeds to step 416, whereby the operator places the bucket that is to receive the current ingredient on the scale. During the first iteration of routine 400, the bucket will be empty at step 416. Next, at step 420, the operator scans the bar code label corresponding to the bucket currently on the scale. At decision block 422 monitoring station 14 verifies that the bucket is valid based on the bar code that was read during step 420. In particular, the bucket is validated based on the unreconciled ingredient setup process 300 described above to ensure that the proper ingredients will be mixed in the predetermined buckets. Accordingly, for the first unreconciled ingredient to be added, monitoring station 14 ensures that the status of the scanned bucket is empty. In subsequent iterations, monitoring station 14 will ensure that the proper combinations of ingredients in their predetermined quantities will be added to a given bucket. Once the bucket has been validated, the weight of the bucket is measured at step 418.

At step 424, the operator fills the bucket with the current unreconciled ingredient to be added. The weight of the added ingredient is constantly recorded and displayed by monitoring station 14 at bar graph 810 based on the weight of the bucket on the scale. The bag weight is not recorded because the ingredient being added is unreconciled. Once the quantity of added ingredient has been accepted at decision block 426, the weight of the bucket is measured and recorded if the previously added ingredient was at step 428. It should also be appreciated that the weight of a bucket containing reconciled ingredients can also be measured and recorded in accordance with an alternate embodiment of the invention in order to validate the weight of the bucket during subsequent mixing steps with bulk ingredients.

Next, at decision block 430, if the previously added ingredient is not the last ingredient to be added to the current batch, monitoring station 14 prompts the user that the next ingredient is going to be added at step 432, and routine 400 reverts to decision block 404. Once the monitoring station 14 determines that the last ingredient has been added at decision block 430, the routine 400 proceeds to step 434, whereby the monitoring station 14 determines whether any additional batches of the current run are to be prepared. If so, monitoring station 14 prompts the user to begin a new batch at step 436, and identifies the first ingredient at step 438. Monitoring station 14 then repeats steps 404-438 for each batch that is to be prepared during the current production run. Once the last batch of the run has been prepared as determined at decision block 434, routine 400 ends at step 440.

Multiple Bucket Setup Routines

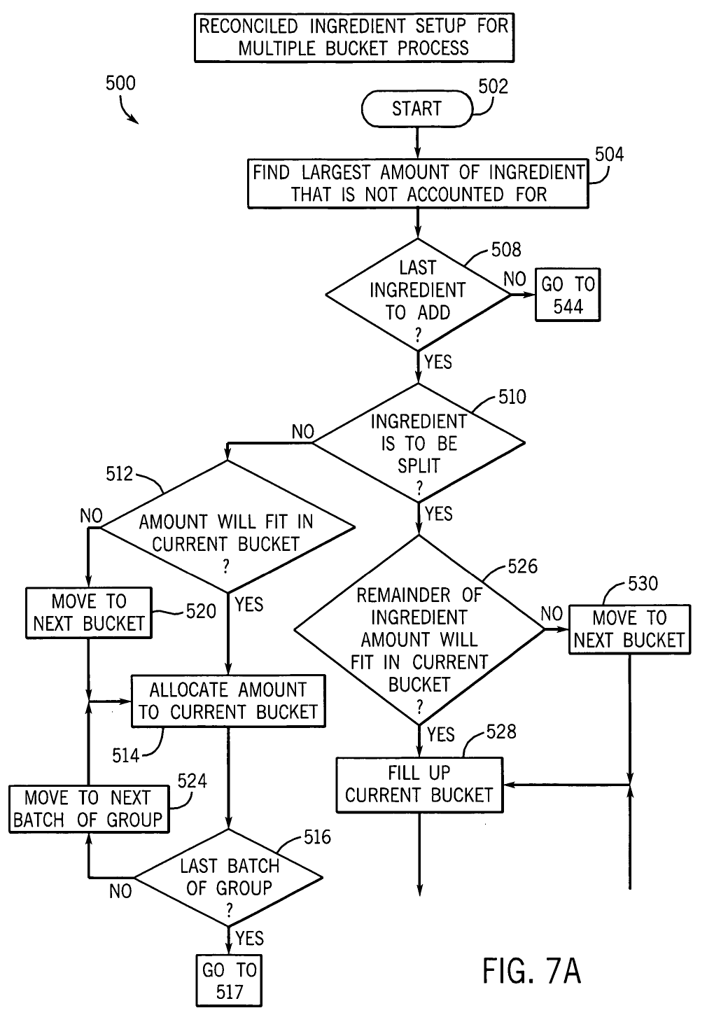

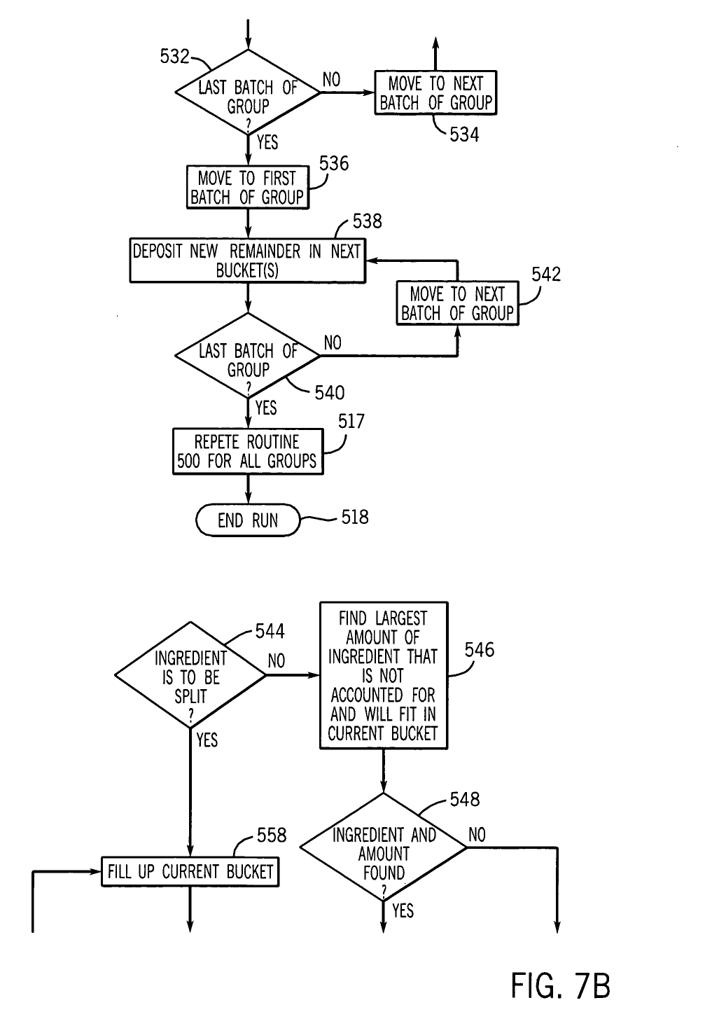

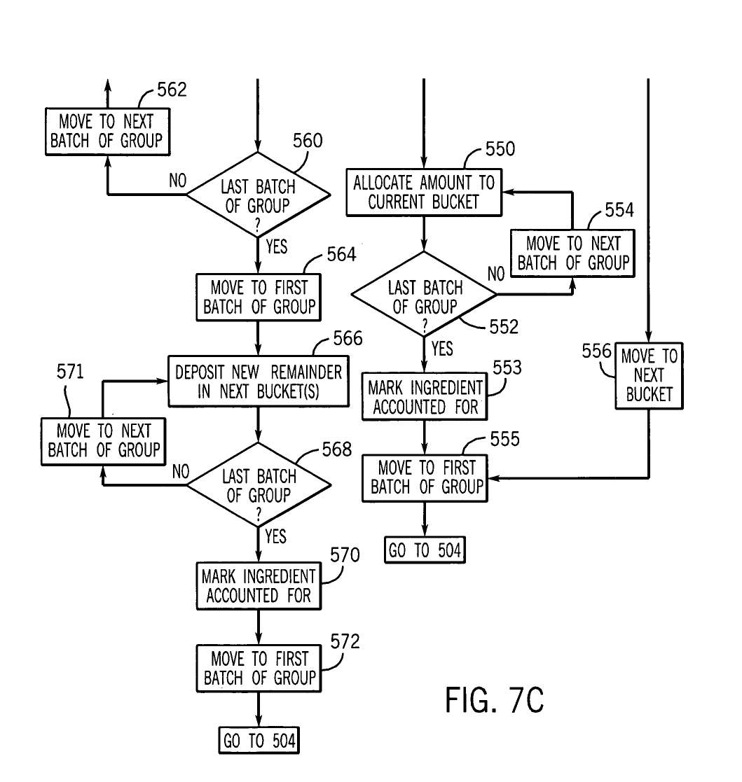

As described above with reference to FIG. 2, if the operator has configured monitoring station 14 to perform a multiple bucket process 73, process 50 continues from decision block 58 to decision block 74. At decision block 74, monitoring station 14 determines whether any reconciled ingredients are to be added to the current run. If so, the monitoring station 14 executes a reconciled multiple bucket setup mode routine 500 at step 76, as will now be described with reference to FIGS. 7A-7C.

It should be appreciated that routine 500 is executed when multiple buckets can fit on the scale at a given time, and the operator wishes to produce multiple batches simultaneously. Buckets are placed on the scale in “groups” of batches. For instance, if a production run contains ten batches, and four buckets will fit on the scale at a given time, monitoring station 14 will prepare the run in two groups of four batches, and a third group of two batches. Accordingly, during the multiple bucket weighing routine 700, the operator will follow instructions from monitoring station 14 and, in the above example, fill a first group of four batches, then a second group of four batches, and finally a third group of two batches. Accordingly, all ten batches of the production run will be prepared while tracking the reconciled ingredients in accordance with the preferred embodiment of the present invention.

Routine 500 begins at step 502 and proceeds to step 504 where monitoring station 14 identifies that the ingredient that has not yet been allocated and that has the greatest quantity among the other unallocated ingredients to be added to the current batch. Accordingly, ingredients will be allocated to buckets in the order of descending quantity, which enables monitoring station 14 to minimize the number of buckets used for a given batch, as will become more apparent from the description below.

If the ingredient identified at step 504 is not the last ingredient to be added as determined at decision block 508, routine 500 proceeds to decision block 544. At decision block 544, the monitoring station 14 determines whether the quantity of the ingredient to be allocated is greater than the capacity of an empty bucket. If so, the ingredient is deemed “split.”

If not, the ingredient will not be split and, instead, monitoring station 14 will identify among the list of unallocated ingredients, which ingredient has the greatest quantity that will fit in the available volume of the current bucket at step 546. In other words, monitoring station 14 will determine whether the bucket can be filled with the entire quantity of the current ingredient, or any other ingredient that is to be added to the current batch. If such an ingredient and amount is found at decision block 548, that ingredient is allocated to the current bucket at step 550. At decision block 552, if the ingredient has not yet been allocated for all batches in the group, routine 500 proceeds from decision block 552 to step 554 until the ingredient is allocated for all batches of the group at step 550. Next, at step 553, once all batches have been accounted for in the previous iteration, monitoring station 14 marks the previously allocated ingredient as “accounted for.” Monitoring station then identifies the first batch of the group at step 555 in preparation for the allocation of the next ingredient.

If, on the other hand, a suitable ingredient is not found at decision block 548, monitoring station 14 identifies a new, empty bucket at step 556. Accordingly, the ingredient that was identified at step 504 will still be the largest quantity of unallocated ingredient during the next iteration of routine 500. Because that ingredient is not a split ingredient, it will be fully allocated to the new empty bucket that was selected at step 556 during the next iteration of routine 500. Monitoring station 14 identifies the first batch in the group at step 555, as described above. It should thus be appreciated that, if no ingredient is identified at decision block 548, monitoring station 14 will not mark any ingredients as “accounted for.” Routine 500 proceeds from step 555 to step 504.

If, at decision block 544, the ingredient initially identified at step 504 is to be split, meaning that the amount of the ingredient to be added is greater than the volume of an empty bucket, routine 500 proceeds to step 558. At step 558, monitoring station allocates as large a quantity as possible of the current ingredient to fill the current bucket to capacity. Decision block 560 and step 562 ensure that step 558 is repeated for each bucket (and batch) on the scale for the current group. Once the volume of all buckets has been reserved with ingredients, monitoring station 14 identifies the first batch of the group at step 564 in order to continue filling the split ingredient. In particular, at step 566, the remainder of the ingredient is allocated to a next empty bucket, and any additional buckets that are necessary to allocate the entire quantity of the current ingredient. Decision block 568 and step 571 ensure that step 566 is repeated for all batches of the current group that is being allocated.

Once step 566 has been repeated for all batches of a given run, the previously added ingredient is marked “accounted for” at step 570, and monitoring station 14 identifies the first batch of the group at step 572 in preparation for the addition of the next ingredient to all batches of the current group. Process 500 then reverts to step 504.

Once monitoring station 14 identifies the next ingredient to allocate at step 504, and also determines that the current ingredient is the last ingredient to add at decision block 508, the monitoring station then determines whether the last ingredient is to be split at decision block 510. If the quantity of the last ingredient to be added is less than the volume of an empty bucket, the ingredient is not split and routine 500 continues to decision block 512. At decision block 512, the monitoring station 14 determines whether the current available volume of the current bucket is sufficient to contain the entire quantity of the last ingredient. If so, the last ingredient is allocated to the current bucket at step 514. Decision block 516 and step 524 ensure that step 514 is repeated for all batches of the current group.

If, on the other hand, the available volume of the current bucket is insufficient for the last ingredient as determined at decision block 512, routine 500 continues to step 520, whereby monitoring station 14 selects a new bucket for the group, and allocates the last ingredient to the new bucket at step 514. Decision block 516 and step 524 ensure that the last ingredient is allocated to a new bucket for all batches in the group. Once the last ingredient has been fully accounted for, routine 500 proceeds to step 517.

If, on the other hand, monitoring station 14 determines at decision block 510 that the quantity of the last ingredient exceeds the available quantity of an empty bucket, the ingredient will be split and routine 500 then proceeds to decision block 526. At decision block 526, monitoring station 14 divides the quantity of the last unallocated ingredient by available volume of an empty bucket, and calculates the quotient as a whole number having a remainder. Monitoring station 14 determines whether the remainder will fit into the current bucket at decision block 526. If so, the remainder of the ingredient is allocated into the current bucket at step 528. Decision block 532 and step 534 ensure that the remainder of the last ingredient is allocated at step 528 for each remaining bucket of the group. Routine 500 then proceeds to step 536.

Alternatively, if the remainder of the last ingredient will not fit into the current bucket as determined at decision block 526, monitoring station 14 identifies a new empty bucket at step 530. A sufficient quantity of the ingredient is then allocated to the empty bucket in order to fill the bucket to capacity. Steps 532 and 534 ensure that the ingredient is allocated to a new bucket for each batch in the current group.

Next, at step 536, monitoring station identifies the first batch of the group, and deposits the new remainder of the ingredient (after allocation of the initial quantity at step 528) is allocated into as many buckets as necessary to consume the entire quantity of the last remaining ingredient. Decision block 540 and step 542 ensure that the entire quantity of the last ingredient is allocated for each bucket of the group. Next, at step 517, the previously determined allocation is repeated for the predetermined number of groups for the current production run. Routine 500 ends at step 518.

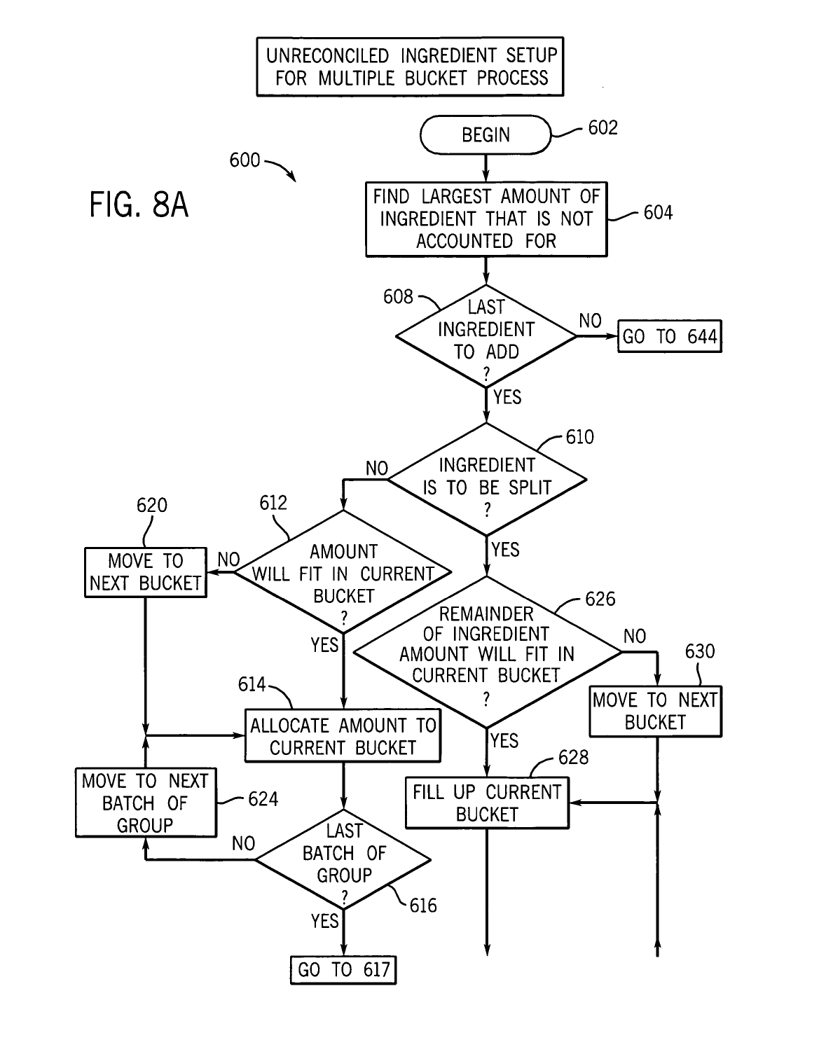

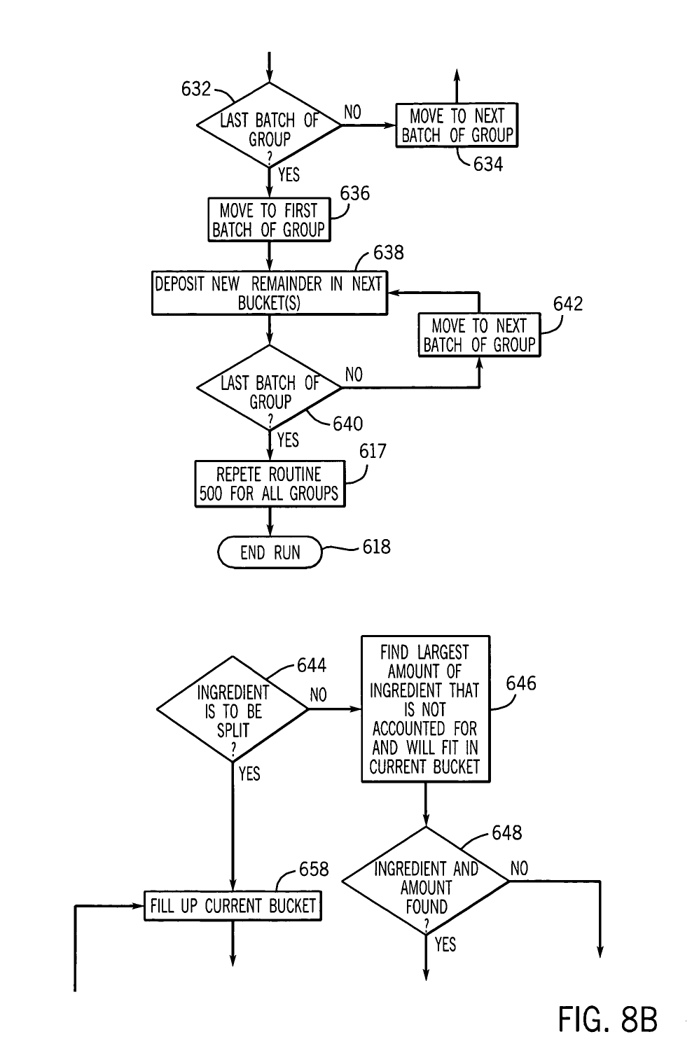

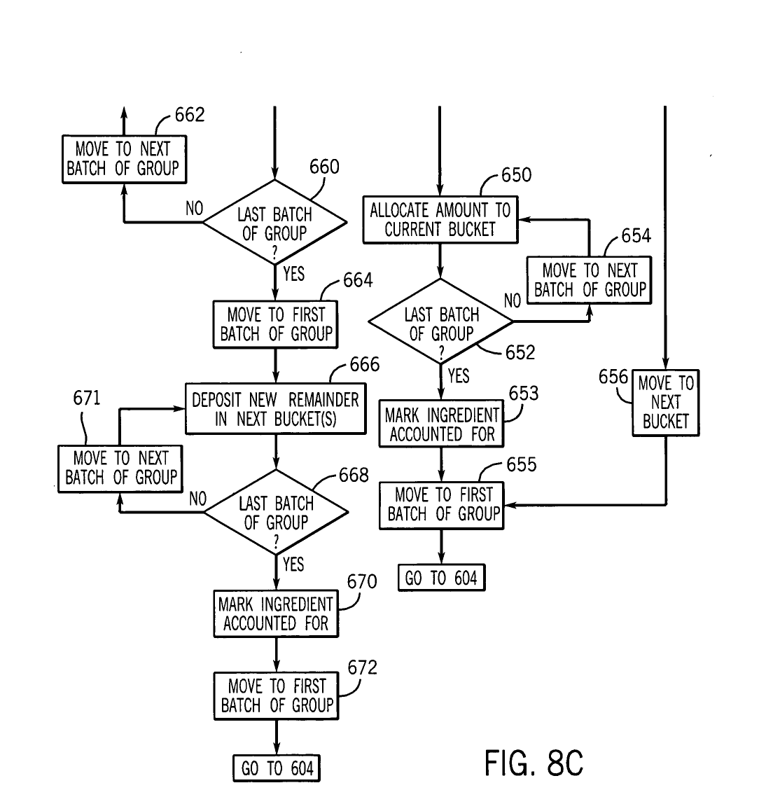

Referring again to FIG. 2, once multiple buckets set up 500 is complete, process 50 continues to decision block 78, where monitoring station 14 determines whether the current run includes unreconciled ingredients at decision block 78. If so, or if no reconciled ingredients were identified at decision block 74, monitoring station 14 executes an unreconciled multiple buckets set up routine 600 as illustrated in FIGS. 8A-8C. In particular, for the purposes of clarity and convenience, the steps of reconciled routine 500 illustrated in FIGS. 7A-7C have been incremented by 100 for unreconciled routine 600 illustrated in FIGS. 8A-8C for the purposes of clarity and convenience. Because routine 600 is identical to routine 500, but for the fact that routine 600 is performed with reference to the unreconciled ingredients that are to be added to the batch(es) using the multiple bucket process 73, the steps of method 600 are not described individually herein. Processes 500 and 600 thus enable monitoring station 14 to provide instructions to the user regarding the sequence, identity, and amounts of the various ingredients of the current run that are to be added to the various buckets during the multiple ingredient weighing routine 700.

Multiple Ingredient Weighing Routine

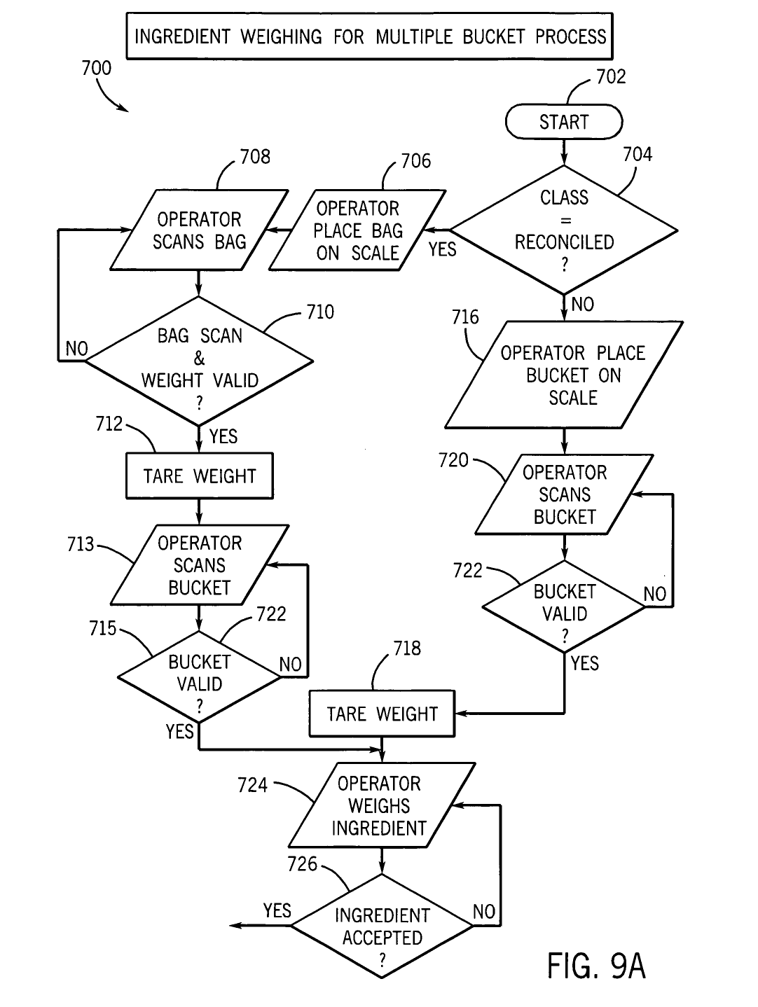

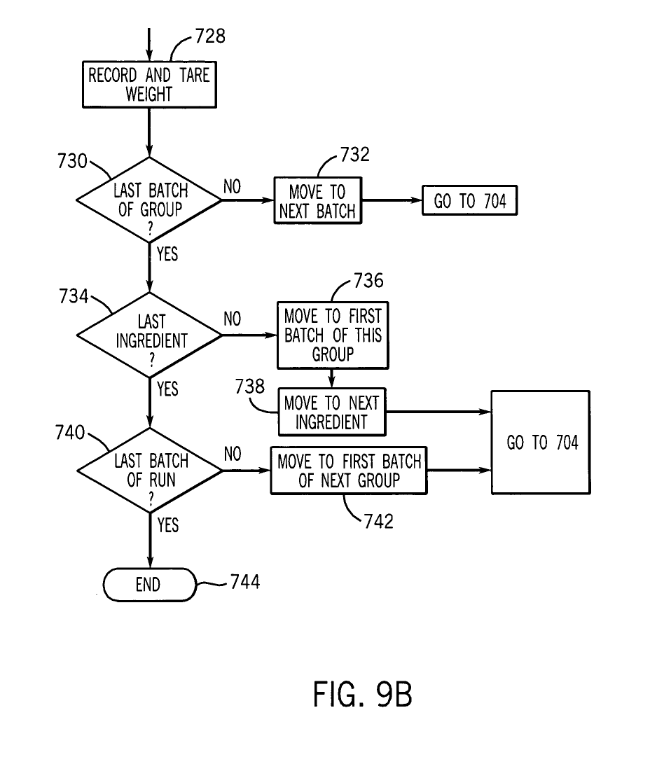

As discussed above with reference to FIG. 2, once step 80 has been completed, process 50 continues to step 82, whereby monitoring station 14 initiates the ingredient weighing routine 700 for multiple buckets, as will now be described with reference to FIGS. 9a-b. In particular, routine 700 begins at step 702 and proceeds to decision block 704, whereby monitoring station 14 determines whether the current class of ingredient to be added is reconciled. If so, operator places the bag containing the current ingredient to be added, as displayed by monitoring station 14, onto scale 20 at step 706. The bar code label corresponding to the bag placed on the scale is scanned at step 708. Decision block 710 verifies that the bag contains the proper ingredient, and that the weight of the bag (1) equals (or is within a predetermined tolerance of) the weight of the new bag if the bag is new; or (2) equals (or is within a predetermined tolerance of) the weight of the bag last recorded after the bag was previously used during a previous run.

Once the bag scan has been validated at decision block 710, monitoring station 14 tares the weight of the bag at step 712. The operator then retrieves and scans the first bucket to be used for the first batch of the group at step 713, as prompted by monitoring station. Preferably the operator has already retrieved a number of buckets in order to prepare a plurality of batches for the group. The bucket is scanned at step 713 and validated by the monitoring station 14 at step 715 to ensure that the bucket can be used with the current run.

Once the bucket has been validated, the operator begins moving quantities of the reconciled ingredient into the bucket at step 724 using a manual scoop or other suitable device. The monitoring station 14 displays the weight added to the user via bar graph 810 and sets the target weight equal to the quantity for that ingredient that was determined during routine 500. Once the predetermined quantity of the ingredient has been added to the bucket as determined at decision block 726, the ingredient will be accepted and the new weight of the bag will be recorded and tared at step 728. The new weight of the bag is forwarded to inventory monitoring station 34 for future use.

If, however, it is determined at decision block 704 that the ingredient to be added is an unreconciled ingredient, routine 700 continues to step 716 whereby the operator places one bucket on the scale 22 (or scale 20 if system uses a single scale) corresponding to each group. The bar code label of the first bucket is then scanned at step 720 and the bucket is validated at decision block 722. Next, monitoring station 14 tares the weight of the bucket at step 718, at which point the operator begins adding the unreconciled ingredient from the bag to the bucket at step 724. Once the predetermined quantity of the ingredient to be added as determined during process 600 has been added to the bucket, the ingredient is accepted at decision block 726 and routine 700 continues to step 728, whereby the weight of the bucket is recorded and tared.

It should be appreciated, as described above with reference to routine 400, that the quantity of unreconciled ingredient added is verified based on the weight of the bucket, while the quantity of the reconciled ingredient added is verified based on the weight of the bag. It should be appreciated, however, that in an alternate embodiment of the invention, both the weight of the bag containing the ingredient along with the bucket receiving the reconciled ingredient can be continuously monitored by station 14 to ensure that all reconciled ingredient removed from the bag is added to the bucket.

At decision block 730, monitoring station 14 determines whether the ingredient added at step 724 corresponded to the last batch of the current group. If not, monitoring station 14 proceeds to the next batch at step 732 and returns to step 704. Accordingly, steps 704-732 are repeated for all batches in the current group, at which point process 700 proceeds to decision block 734 and monitoring station 14 determines whether the ingredient added at step 724 was the last ingredient to be added, as determined by routines 500 and 600. If not, monitoring station 14 reverts to the first batch of the group at step 736, and prompts the operator at step 738 as to the identity and quantity of the next ingredient to be added. Routine 700 is then repeated for the next ingredient, and all subsequent ingredients for all batches in the group. Once decision block 734 indicates that the last ingredient was added, monitoring station determines whether the last batch of the present group was the last batch of the run. If not, monitoring station 14 alerts the user that the next group of batches is to be filled with ingredients at step 742. Routine 700 then repeats for the next group, and subsequent groups until all batches of the current run have been filled, and routine 700 then terminates at step 744.

It should thus be appreciated that process 50 enables a monitoring station 14 to allocate ingredients that are to be added to a given mix, prompt the user to add the correct quantities of the correct ingredients in the correct sequence, and verify the quantities of reconciled ingredients to ensure that all such ingredients are accounted for. Method 50 described above was performed for a stand-alone mixing station. However, it should be appreciated that mixing station 14 may alternatively be integrated into an automated bulk batching system as will now be described.

Integrated System

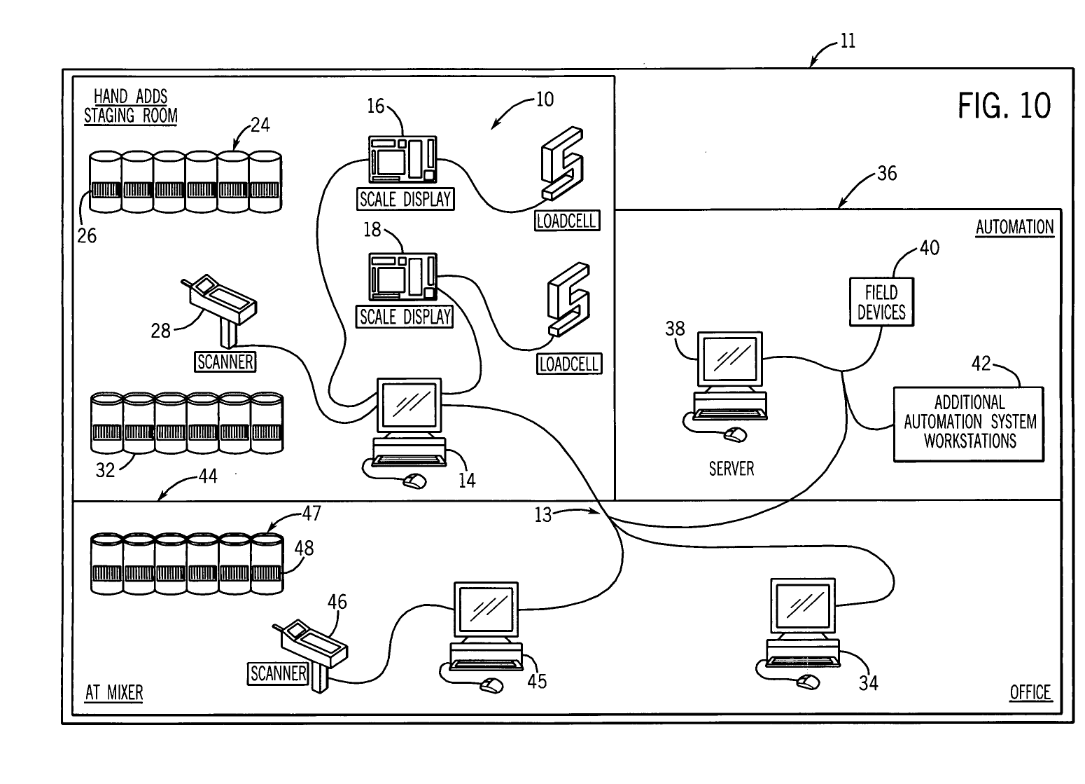

Referring now to FIG. 10, an integrated system 11 includes a bulk automated batching system 36 having a server 38 that automatically controls field devices 40 and automation system workstations 42 that, in combination, produce batches of bulk ingredients, such as wheat, corn, soy, limestone, salt, beet pulp, and the like. Server 38 is connected to a network 13 including commodity monitoring station 14, inventory monitoring station 34, and a mixing station 45 that will be described in more detail below. Inventory monitoring station 34 tracks the available quantity of bulk ingredients. Accordingly, the user can be prompted when a supply of a given ingredient is below a predetermined threshold. Commodity monitoring station 14 and server 38 communicate to ensure that the automated system 36 thus produces a number of batches that corresponds in quantity to the to the number of batches produced at the hand-added staging room 10 described above.

When commodity monitoring station 10 is integrated with automation system 36, a mixing station 44 is provided having a monitoring station 45 that is connected to a bar code scanner 46. Mixing station may be located remotely from hand-added staging room 10 and automated system 36, or alternatively may be local to hand-added staging room 10 or automated system 36. Alternatively still, all three regions 10, 36, and 44 may be local to one another. A plurality of buckets 47 is provided that were prepared by hand-adding ingredients using the commodity monitoring system 10. Buckets 47 thus carry corresponding bar code labels 48 to identify and verify that the proper ingredients are being added to the mix.

During operation, with reference to FIG. 11F, all bags and buckets to be added to the batch in the mixer (not shown) are displayed in the “Production View” region 806 when the operator selects “mixer” mode 824. The requirements of the mixer batch for the current production run will be displayed, including the identification of, and quantity of, the bags/buckets, the ingredient code and description, the bar code of the bag/bucket, the serial number, the batch number, and whether the bag/bucket has been verified. A bag/bucket will be verified once the corresponding bar code has been scanned by the operator and verified by monitoring station 14, as described above. In addition to the steps described above with respect to hand-added ingredient preparation that are performed whether the monitoring system 10 is a stand-alone system or an integrated system, monitoring station 14 provides an additional step when the monitoring system is integrated with a mixing system. In particular, monitoring station 14 prompts the operator, after a bucket, batch, group, or run is prepared, to deposit the contents of the buckets into the mixer. At times, the operator may be prompted to add full bags to the mixer, for example when the bags contain unreconciled ingredients.

The integrated system 11 thus enables batches of hand-added ingredients to be added to bulk ingredients to produce a mixture, containing FDA-regulated ingredients, that can be mass-produced and administered to farm animals and the like. Advantageously, the system 11 enables the production of such a mixture while reconciling regulated ingredients as mandated by the FDA while avoiding the conventional time-consuming, paper intensive, and imperfect system of manual reconciliation.

The invention has been described in connection with what are presently considered to be the most practical and preferred embodiments. However, the present invention has been presented by way of illustration and is not intended to be limited to the disclosed embodiments. For instance, it should be appreciated that the present invention is not to be limited to a stand-alone system or an integrated system. Accordingly, those skilled in the art will realize that the invention is intended to encompass all modifications and alternative arrangements included within the spirit and scope of the invention, as set forth by the appended claims.

We claim:

1. A batching system for controlling ingredients that are manually added to a batch via at least one transfer container, wherein the ingredients include reconciled ingredients and unreconciled ingredients that are initially disposed in origin containers, the system comprising:
a first sensor for measuring an amount of an ingredient in a container;
a second sensor for identifying an ingredient in a container; and
a computer communicating with the first and second sensors and having a user interface, wherein the computer executes a stored program configured to:
i. identify a quantity and identity of a reconciled ingredient to be added to the batch from a recipe;
ii. verify the origin container of the ingredient identified in (i);
iii. measure a quantity related to the origin container of the reconciled ingredient before the ingredient is added to the batch; and
iv. measure and log the quantity related to the origin container of the reconciled ingredient after the ingredient is added to the batch.

2. The system as recited in claim 1, wherein the first sensor comprises a scale.

3. The system as recited in claim 2, wherein the quantity related to the origin container is a weight.

4. The system as recited in claim 1, wherein the second sensor comprises a bar code scanner operable to read bar codes disposed on each origin container containing a reconciled ingredient.

5. The system as recited in claim 4, wherein the bar code scanner is operable to read bar codes disposed on each transfer container.

6. The system as recited in claim 1, wherein the stored program is further configured to verify that the measured quantity during (iii) is within a tolerance of a previously logged quantity.

7. The system as recited in claim 1, wherein the stored program is further configured to:
v. identify a quantity and identity of an unreconciled ingredient to be added to the batch from the recipe; and
vi. measure the quantity of the transfer container receiving the unreconciled ingredient after the unreconciled ingredient is added to the batch.

8. The system as recited in claim 1, wherein the transfer container is identified prior to the reconciled ingredient being added to the batch.

9. The system as recited in claim 1, wherein the stored program is further configured to map a predetermined order in which the ingredients are to be added to the batch.

10. The system as recited in claim 9, wherein ingredients are added in a descending order of quantity to be added to the batch.

11. The system as recited in claim 9, wherein an ingredient is split if the quantity of the ingredient to be added to the batch is greater than an available volume in an empty transfer container.

12. The system as recited in claim 9, wherein stranded transfer containers containing ingredients of the recipe are added to the batch.

13. The system as recited in claim 9, wherein multiple batches are prepared simultaneously.

14. The system as recited in claim 1, wherein the stored program is further configured to display messages via the user interface to an operator regarding the identity and quantity of a next ingredient to be added.

15. The system as recited in claim 1, wherein the stored program is further configured to track lot numbers corresponding to origin containers of those reconciled ingredients that are controlled ingredients.

16. The system as recited in claim 1, further comprising a mixing station integrated with the batching system for mixing the batches with bulk ingredients.

17. The system as recited in claim 1, further comprising an inventory monitoring station receiving data obtained by the first and second sensors for tracking a quantity of available origin containers.

18. A business method for controlling ingredients that are manually added to a batch via at least one transfer container, the method comprising:
A) providing a plurality of ingredients including reconciled and unreconciled ingredients disposed in corresponding origin containers;
B) providing a first sensor for measuring an amount of an ingredient in a container;
C) providing a second sensor for identifying an ingredient in a container; and
D) providing a computer communicating with the first and second sensors and having a user interface, wherein the computer executes a stored program that:
i. identifies a quantity and identity of a reconciled ingredient to be added to the batch from a recipe;
ii. verifies the origin container of the ingredient identified in (i);
iii. measures a quantity related to the origin container of the reconciled ingredient before the ingredient is added to the batch; and
iv. measures and logs the quantity related to the origin container of the reconciled ingredient after the ingredient is added to the batch.

19. The system as recited in claim 18, wherein the stored program further verifies that the measured quantity during (iii) is within a tolerance of a previously logged quantity.

20. The system as recited in claim 18, wherein the stored program further:
v. identifies a quantity and identity of an unreconciled ingredient to be added to the batch from the recipe; and
vi. measures the quantity of the transfer container receiving the unreconciled ingredient after the unreconciled ingredient is added to the batch.

21. The system as recited in claim 18, wherein the transfer container is identified prior to the reconciled ingredient being added to the batch.

22. The system as recited in claim 18, wherein the stored program further maps a predetermined order in which the ingredients are to be added to the batch.

23. The system as recited in claim 22, further comprising mapping ingredients to be added to the batch generally in an order of descending quantity.

24. The system as recited in claim 22, further comprising splitting an ingredient if the quantity of the ingredient to be added to the batch is greater than an available volume in an empty transfer container.

25. The system as recited in claim 22, further comprising adding stranded transfer containers containing ingredients of the recipe to the batch.

26. The system as recited in claim 22, further comprising preparing multiple batches of the same ingredient simultaneously.

27. The system as recited in claim 18, further comprising displaying messages to an operator via the operator interface regarding the identity and quantity of a next ingredient to be added.

28. The system as recited in claim 1, further comprising tracking lot numbers corresponding to origin containers of those reconciled ingredients that are controlled ingredients.

29. The system as recited in claim 1, further comprising integrating the batching system with a mixing station integrated for mixing the batches with bulk ingredients.

30. The system as recited in claim 1, further comprising tracking a quantity of controlled ingredients.
